(19) United States
(12) Patent Application Publication
(10) Pub. No.: US 2025/0109280 A1
(43) Pub. Date: Apr. 3, 2025

(54) HEAT-EXPANDABLE MICROSPHERES, HOLLOW PARTICLES AND APPLICATION THEREOF

(71) Applicant: MATSUMOTO YUSHI-SEIYAKU CO., LTD., Yao-shi, Osaka (JP)

(72) Inventor: Naoya TAYAGAKI, Yao-shi, Osaka (JP)

(73) Assignee: MATSUMOTO YUSHI-SEIYAKU CO., LTD., Yao-shi, Osaka (JP)

(21) Appl. No.: 18/729,012

(22) PCT Filed: Jan. 18, 2023
(86) PCT No.: PCT/JP2023/001244

§ 371 Date: Jul. 15, 2024

(30) Foreign Application Priority Data
Jan. 21, 2022 (JP) 2022-007763

(51) Int. Cl. C08K 9/10; B01J 13/14

(52) U.S. Cl. CPC C08K 9/10; B01J 13/14

(57) ABSTRACT

Heat-expandable microspheres comprise a shell containing a thermoplastic resin, a thermally gasifiable blowing agent and an organic silicon compound. The blowing agent is encapsulated in the shell, and the organic silicon compound exists below the outside surface of the shell and/or on the outside surface of the shell, the organic silicon compound contains at least one unit selected from T unit represented by R¹SiO_{3/2} and D unit represented by R²₂SiO_{2/2}, and each of R¹ and R² is a monovalent organic group having 1 to 15 carbon atoms.

### CROSS-REFERENCE TO RELATED APPLICATIONS

This application is a National Stage of International Application No. PCT/JP2023/001244 filed Jan. 18, 2023, claiming priority from Japanese Patent Application No. 2022-007763 filed Jan. 21, 2022.

### BACKGROUND OF THE INVENTION

### Field of the Invention

The present invention relates to heat-expandable microspheres, hollow particles and application thereof.

### Description of the Related Art

Heat-expandable microspheres (heat-expandable microcapsules) composed of a shell of thermoplastic resin and a blowing agent encapsulated therein can be expanded by heating.

Heat-expandable microspheres are usually used by mixing with a base material and expanded by heating the mixture in order to lighten the base material and impart design potential and cushioning effect to the base material.

Recently, hollow particles manufactured by expanding heat-expandable microspheres and having an almost spherical shape have found use as functional additives to a base material.

For example, the recent trend of growing awareness to environmental problems such as global warming and air pollution has increased the demand for reducing the weight of automobiles to improve their fuel efficiency. Thus, automobile manufacturers have sought to reduce the weight of automotive parts and reduce the weight of automotive paints by blending hollow particles manufactured by expanding heat-expandable microspheres into organic sol materials used as paints.

Hollow particles manufactured by expanding ordinary heat-expandable microspheres, however, can fail to impart the requisite properties to base materials. This is because of their deformation, i.e., rupturing or denting, caused by a high pressure load applied to the hollow particles during blending with base materials and processing, specifically, pumping and application of a paint containing hollow particles.

Recently, as disclosed in PTL 1, heat-expandable microspheres having a shell of a polymer with a degree of cross-linking of at least 60 wt % composed of a monomer mixture containing at least 95 wt % of (meth)acrylonitrile in which at least 70 wt % of acrylonitrile is contained have been developed. Such heat-expandable microspheres have a shell of highly improved strength and are sufficiently durable against external forces applied to the microspheres in processing.
[PTL 1] Japanese Patent Application Publication 2010-132860

### Problems to be Solved by the Invention

Although the heat-expandable microspheres proposed in PTL 1 are durable against external forces in processing before they are expanded, hollow particles manufactured by expanding the heat-expandable microspheres have a shell thinner than the shell of unexpanded microspheres and mechanical strength and have lower mechanical strength. It has already been found that the shell of such hollow particles is ruptured or dented to deform spherical particles when subjected to a high pressure load, such as a pressure load of 20 MPa or higher applied to the hollow particles contained in paints, and the hollow particles fail to lighten base materials.

As mentioned above, hollow particles durable against high pressure to resist their deformation, such as rupture or dent and heat-expandable microspheres to be manufactured into such hollow particles have not yet been proposed.

### SUMMARY OF THE INVENTION

It is therefore an object of the present invention to provide hollow particles durable against high pressure to resist their deformation, such as rupture or dent, heat-expandable microspheres to be manufactured into such hollow particles, and application thereof.

Following diligent study, the present inventors discovered that the above problem can be solved by specific heat-expandable microspheres to achieve the present invention.

The heat-expandable microspheres of the present invention comprise a shell containing a thermoplastic resin, a thermally gasifiable blowing agent and an organic silicon compound; wherein the blowing agent is encapsulated in the shell; the organic silicon compound exists below the outside surface of the shell and/or on the outside surface of the shell; the organic silicon compound contains at least one unit selected from T unit represented by R¹SiO_{3/2} and D unit represented by R²₂SiO_{2/2}; and each of R¹ and R² is a monovalent organic group having 1 to 15 carbon atoms.

The heat-expandable microspheres of the present invention preferably further satisfy at least one of the following requirements of 1) to 4).
1) The organic silicon compound has a silanol group and/or an alkoxysilyl group.
2) The thermoplastic resin is a polymer of a polymerizable component containing an uncross-linkable monomer having one polymerizable carbon-carbon double bond and the uncross-linkable monomer contains a nitrile monomer.
3) The thermoplastic resin is a polymer of a polymerizable component containing an uncross-linkable monomer having one polymerizable carbon-carbon double bond and the uncross-linkable monomer contains a carboxyl-group-containing monomer.
4) The content of the organic silicon compound ranges from 0.05 parts by weight to 50 parts by weight to 100 parts by weight of the heat-expandable microspheres.

The hollow particles of the first embodiment of the present invention are the expansion product of the heat-expandable microspheres described above.

Following diligent study, the present inventors discovered that the above problem can be solved by the specific hollow particles of the second embodiment of the present invention.

The hollow particles of the second embodiment of the present invention comprise a shell containing a thermoplastic resin, a hollow portion surrounded by the shell, and an organic silicon compound; wherein the organic silicon compound exists below the outside surface of the shell and/or on the outside surface of the shell; the organic silicon compound contains at least one unit selected from T unit represented by R¹SiO_{3/2} and D unit represented by R²₂SiO_{2/2}; and each of R¹ and R² is a monovalent organic group having 1 to 15 carbon atoms.

The hollow particles of the second embodiment of the present invention preferably have a specific gravity ranging from 0.005 to 0.6.

The fine-particle-coated hollow particles of the present invention comprise the hollow particles described above and fine particles coating the outside surface of the shell of the hollow particles.

The composition of the present invention comprises at least one selected from the group consisting of the heat-expandable microspheres, hollow particles and fine-particle-coated hollow particles described above, and a base component.

The formed product of the present invention is manufactured by forming the above-described composition.

### Advantageous Effects of the Invention

The heat-expandable microspheres of the present invention contribute to the manufacture of hollow particles having a shell that can resist deformation against a high pressure load.

The hollow particles of the first embodiment of the present invention manufactured from the heat-expandable microspheres mentioned above have a shell that can resist deformation against a high pressure load.

The hollow particles of the second embodiment of the present invention have a shell that can resist deformation against a high pressure load.

The fine-particle-coated hollow particles of the present invention comprise the hollow particles mentioned above, and which have a shell that can resist deformation against a high pressure load.

The composition of the present invention comprises at least one of the heat-expandable microspheres, hollow particles and fine-particle-coated hollow particles mentioned above, and which can resist deformation against a high pressure load.

The formed product of the present invention is manufactured by forming the composition and is lightweight.

### BRIEF DESCRIPTION OF THE DRAWINGS

FIG. 1: A schematic diagram of an example of heat-expandable microspheres.

FIG. 2: A schematic diagram of an example of fine-particle-coated hollow particles.

FIG. 3: A schematic diagram of the expansion unit of a device for manufacturing hollow particles by dry thermal expansion.

### REFERENCE NUMBERS LIST

Reference numbers used to identify various features in the drawings include the following:
1 Fine-particle-coated hollow particles
2 Shell
3 Hollow portion
4 Fine particle (in a state of adhesion)
5 Fine particle (in a state of being fixed in a dent)
6 Shell containing a thermoplastic resin
7 Core containing a blowing agent
8 Hot air nozzle
9 Refrigerant flow
10 Overheat prevention jacket
11 Distribution nozzle
12 Collision plate
13 Gas fluid containing heat-expandable microspheres
14 Gas flow
15 Hot airflow

### DETAILED DESCRIPTION OF PREFERRED EMBODIMENTS

The heat-expandable microspheres of the present invention are specifically described as follows and in reference to the drawings. However, the present invention should not be construed as being limited thereto.

The heat-expandable microspheres of the present invention comprise a shell containing a thermoplastic resin, a thermally gasifiable blowing agent and an organic silicon compound, and the whole of a microsphere is thermally expandable (a microsphere wholly expandable by heating).

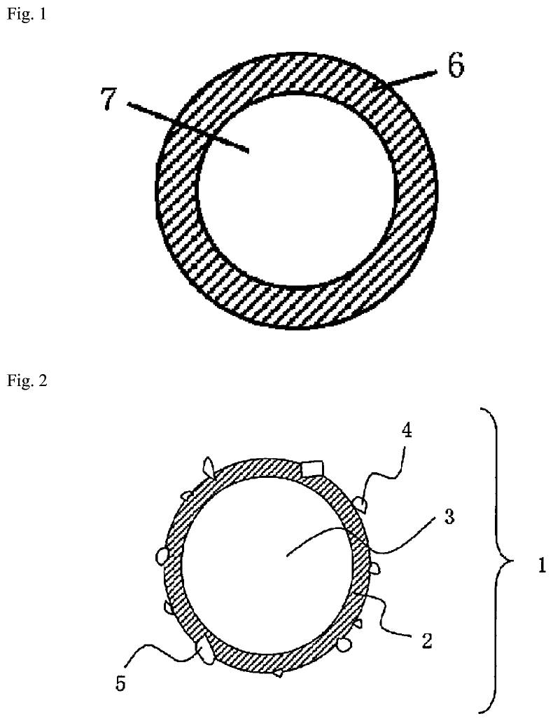

The heat-expandable microspheres of the present invention have a core-shell structure composed of a shell 6 containing a thermoplastic resin and a portion 7 containing a blowing agent as shown in FIG. 1.

The heat-expandable microspheres of the present invention contain an organic silicon compound having at least one unit selected from the group consisting of T unit which is a siloxane unit represented by R¹SiO_{3/2} and D unit which is a siloxane unit represented by R²₂SiO_{2/2} wherein each of R¹ of T unit and R² of D unit is a monovalent organic group having 1 to 15 carbon atoms. Furthermore, the organic silicon compound exists below the outside surface of the shell of the heat-expandable microspheres and/or on the outside surface of the shell of the heat-expandable microspheres. In the present invention, “the organic silicon compound existing below the outside surface of the shell of the heat-expandable microspheres” means at least one of the states of the organic silicon compound “existing within the shell of the heat-expandable microspheres”, “existing on the inside surface of the shell of the heat-expandable microspheres” and “being encapsulated in the shell of the heat-expandable microspheres”.

It is estimated that hollow particles manufactured by heating the heat-expandable microspheres contain heated organic silicon compound (heat-treaded organic silicon compound) which at least coats the outside or inside surface of the shell of the hollow particles or exists in the shell to form islands-in-sea structure with the thermoplastic resin of the shell and the heated organic silicon compound supports the shell of the hollow particles to resist the deformation of the shell, such as rupture or dent, against a high pressure load.

The organic silicon compound contained in the heat-expandable microspheres can be identified by analyzing the cross section of a heat-expandable microsphere in elemental analysis techniques, such as wavelength dispersive X-ray spectroscopy (WDX) with an electron probe micro analyzer (EPMA) and energy dispersive X-ray spectroscopy (EDX) with a Scanning electron microscope (SEM).

Although the embodiment of the heat-expandable microspheres of the present invention is not specifically restricted, the organic silicon compound should preferably exist on or below the outside surface of their shell, more preferably below the outside surface of their shell, and further more preferably on the inside surface and/or within their shell for resisting the deformation of the shell of the hollow particles manufactured from the heat-expandable microspheres.

The organic silicon compound is not specifically restricted and preferably contains a silanol group and/or an alkoxysilyl group because siloxane bonds are formed by dehydration condensation of silanol groups, condensation reaction of a silanol group and a hydrolyzable alkoxysilyl group, or condensation reaction of hydrolyzable alkoxysilyl groups to increase the strength of heat-treated organic silicon compound.

The alkoxy groups contained in the alkoxysilyl group include, for example, methoxy group and ethoxy group.

The organic silicon compound containing a silanol group and/or an alkoxysilyl group can contain a structural unit having a hydroxyl group and/or alkoxy group bonded to a silicon atom. Specifically the structural unit incudes, (XO)RSiO_{2/2} unit, (XO)₂RSiO_{1/2} unit, (XO)SiO_{3/2} unit, (XO)₂SiO_{2/2} unit, and (XO)₃SiO_{1/2} unit where XO represents a hydroxyl group or an alkoxy group.

The organic silicon compound is not specifically restricted and should preferably have thermosetting property. The organic silicon compound having thermosetting property efficiently increases the strength of heat-treated organic silicon compound (cured product) during thermal expansion of the heat-expandable microspheres to resist the deformation of the shell of the resultant hollow particles.

The organic silicon compound is not specifically restricted and preferably cures during thermal expansion of the heat-expandable microspheres for a good compromise between the thermal expansion of the heat-expandable microspheres and sufficient pressure resistance of the resultant hollow particles.

The organic silicon compound has at least one unit selected from siloxane units, which are T unit represented by R¹SiO_{3/2} and D unit represented by R²₂SiO_{2/2}, and each of R¹ of T unit and R² of D unit is independently a monovalent organic group having 1 to 15 carbon atoms. R¹ and R² can be the same or different.

R¹ and R² are not specifically restricted and preferably are a hydrocarbon group. The hydrocarbon group includes, for example, alkyl groups, such as methyl group, ethyl group and propyl group; and aromatic groups such as phenyl group. R¹ and R² can have cyclic structure, such as aromatic ring.

The content of the phenyl groups in R¹ of T unit is not specifically restricted and preferably ranges from 0 to 60 mol % to 1 mol of the organic silicon compound, more preferably from 0 to 40 mol %, and further more preferably from 0 to 20 mol %. The content of the phenyl groups within the above-mentioned range results in increased strength and hardness of the heat-treated organic silicon compound, higher hardening rate, and more efficiently resisted deformation of the shell of resultant hollow particles.

The content of the phenyl groups in R² of D unit is not specifically restricted and preferably ranges from 0 to 60 mol % to 1 mol of the organic silicon compound, more preferably from 0 to 40 mol %, and further more preferably from 0 to 20 mol %. The content of the phenyl groups within the above-mentioned range results in increased strength and hardness of the heat-treated organic silicon compound, higher hardening rate, and more efficiently resisted deformation of the shell of resultant hollow particles.

The content of the alkyl groups in R¹ of T unit is not specifically restricted and preferably ranges from 40 to 100 mol % to 1 mol of the organic silicon compound, more preferably from 60 to 100 mol %, and further more preferably from 80 to 100 mol %. The content of the alkyl groups within the above-mentioned range results in increased strength and hardness of the heat-treated organic silicon compound, higher hardening rate, and more efficiently resisted deformation of the shell of resultant hollow particles.

The content of the alkyl groups in R² of D unit is not specifically restricted and preferably ranges from 40 to 100 mol % to 1 mol of the organic silicon compound, more preferably from 60 to 100 mol %, and further more preferably from 80 to 100 mol %. A content of the alkyl groups within the above-mentioned range results in increased strength and hardness of the heat-treated organic silicon compound, higher hardening rate, and more efficiently resisted deformation of the shell of resultant hollow particles.

The total number of the T units and D units in the entire number of the units constituting the organic silicon compound is not specifically restricted and preferably ranges from 40 to 100%, more preferably from 50 to 100%, further more preferably from 60 to 100%, and yet further more preferably from 70 to 100%. An organic silicon compound with the total number of at least 40% forms the network of the organic silicon compound and its heat-treated product, and thus their strength are increased to resist the deformation of the shell of hollow particles. The preferable total number of the T units or D units in the entire number of the units of the organic silicon compound is within the above-mentioned range.

The embodiment of the organic silicon compound is not specifically restricted and an organic silicon compound containing T units is preferable for attaining the effect of the present invention.

The organic silicon compound contains at least one unit selected from the group consisting of T unit and D unit and can contain the unit represented by the general formula (I) shown below.

RₘSi(OX)ₙO_{(4m-n)/2} (I)

R in the general formula (I) is a monovalent organic group having 1 to 15 carbon atoms like as R¹ and R² mentioned above.

In the general formula (I), m is not specifically restricted and preferably ranges from 1.0 to 2.0, more preferably from 1.0 to 1.6, further more preferably from 1.0 to 1.3, yet further more preferably from 1.0 to 1.2, and most preferably from 1.0 to 1.1.

If m is equal to 1.0, the organic silicon compound is composed of T units. If m is equal to 2.0, the organic silicon compound is composed of D units.

In the general formula (I), OX represents hydroxyl group or alkoxy group mentioned above and preferably represents a part of the silanol group or alkoxysilyl group mentioned above.

In the general formula (I), n is at least 0 and preferably is greater than 0 to increase the strength of heat-treated organic silicon compound.

The molecular weight of the organic silicon compound is not specifically restricted and preferably ranges from 250 to 300000. The organic silicon compound having a molecular weight of at least 250 results in increased strength and hardness of its heat-treated product. In addition, such organic silicon compound facilitate the existence of the organic silicon compound below the outside surface of the shell of heat-expandable microspheres. On the other hand, the organic silicon compound having a molecular weight not greater than 300000 does not inhibit the expansion of the heat-expandable microspheres to contribute to the manufacture of lightweight hollow particles. The lower limit of the molecular weight preferably is 400, more preferably 800 and further more preferably 1000. On the other hand, the upper limit of the molecular weight preferably is 200000, more preferably 100000 and further more preferably 50000. Thus the molecular weight preferably ranges from 250 to 200000 and more preferably from 400 to 100000.

The molecular weight of the organic silicon compound having repeat units means an weight average molecular weight which is the weight average molecular weight in terms of polystyrene determined by gel permeation chromatography.

The curing temperature (T_{Gel}) of an organic silicon compound is not specifically restricted and preferably ranges from 100 to less than 300° C., more preferably from 100 to 250° C., and further more preferably from 100 to 220° C. An organic silicon compound having a curing temperature within the above-mentioned range efficiently increases the strength of its heat-treated product (cured product) when the heat-expandable microspheres are thermally expanded, and contributes to the resisted deformation of the shell of resultant hollow particles against a high pressure load.

The curing temperature (T_{Gel}) of an organic silicon compound is confirmed by measuring its dynamic viscoelasticity with a rheometer. In the measurement, an organic silicon compound is heated by constantly increasing temperature to measure the viscosity of the heated organic silicon compound and the point at which the viscosity starts to increase is determined as the curing temperature of the organic silicon compound.

The curing temperature (T_{Gel}) of an organic silicon compound preferably is lower than the maximum expansion temperature (Tₘₐₓ) of heat-expandable microspheres mentioned below for a good compromise between the expansion property of the heat-expandable microspheres and the pressure resistance of the resultant hollow particles.

The organic silicon compound includes, for example, silicone resin and silicone oligomer.

The organic silicon compound includes, for example, KR-220L, KR-220LP, X-40-2667A, X-40-2756, KR-480, KR-216, KR-242A, KR-251, KR-112, KR-211, KR-212, KR-255, KR-271, KR-272, KR-282, KR-300, KR-216, KC-895, KR-515, KR-500, X-40-9225, X-40-9246, X-40-9250, KR-401N, X-40-9227, KR-510, KR-9218, KR-400, X-40-2327, KR-401, KR-213, X-40-9312, X-40-2450, X-40-9300, X-40-9301, KR-517, X-24-9590, KR-516, KR-518, KR-519, KR-513, X-40-9296, KR-511, KR-2710, KR-470, and X-40-2678 manufactured by Shin-Etsu Chemical Co., Ltd.; DOWSIL RSN-6018 Resin Intermediate, RSN-0217 Flake Resin, RSN-0220 Flake Resin, RSN-0233 Flake Resin, RSN-0249 Flake Resin, and RSN-0255 Flake Resin manufactured by Dow Toray Co., Ltd.; and SILRES MK POWDER, MK FLLAKES, SILRES HK46, SILRES H44, SILRES KX, SILRES MP50E and SILRES H62C manufactured by Wacker Asahikasei Silicone Co., Ltd.

The content of the organic silicon compound in heat-expandable microspheres is not specifically restricted and preferably ranges from 0.05 to 50 parts by weight to 100 parts by weight of heat-expandable microspheres. Heat-expandable microspheres containing at least 0.05 parts by weight of the organic silicon compound are manufactured into hollow particles having a shell of increased strength to resist their deformation by external pressure. On the other hand, heat-expandable microspheres containing 50 parts by weight or less of the organic silicon compound are manufactured into lightweight hollow particles. The lower limit of the content preferably is 0.1 parts by weight, more preferably 0.3 parts by weight, further more preferably 0.5 parts by weight, and most preferably 1 parts by weight. On the other hand, the upper limit of the content preferably is 35 parts by weight, more preferably 20 parts by weight, further more preferably 15 parts by weight, and most preferably 10 parts by weight. Thus the content preferably ranges from 0.1 to 35 parts by weight and further more preferably from 0.3 to 20 parts by weight. The content of the organic silicon compound is measured according to the method described in the Example.

The thermoplastic resin constituting the shell of the heat-expandable microspheres of the present invention preferably is a polymer of a polymerizable component which contains uncross-linkable monomer having one polymerizable carbon-carbon double bond (hereinafter sometimes referred to as uncross-linkable monomer) in order to efficiently encapsulate a blowing agent to expand the heat-expandable microspheres.

The polymerizable component can contain cross-linkable monomer having at least two polymerizable carbon-carbon double bonds (hereinafter sometimes referred to as cross-linkable monomer). The uncross-linkable monomer and cross-linkable monomer are reactive in addition reaction and the cross-linkable monomer introduces a cross-linking structure in the thermoplastic resin.

The uncross-linkable monomer includes, for example, nitrile monomers such as acrylonitrile, methacrylonitrile, fumaronitrile and maleonitrile; vinyl halide monomers, such as vinyl chloride; vinylidene halide monomers, such as vinylidene chloride; vinyl ester monomers, such as vinyl acetate, vinyl propionate and vinyl butyrate; carboxyl-group-containing monomers, such as unsaturated monocarboxylic acids including acrylic acid, methacrylic acid, ethacrylic acid, crotonic acid and cinnamic acid, unsaturated dicarboxylic acids including maleic acid, itaconic acid, fumaric acid, citraconic acid and chloromaleic acid, anhydrides of unsaturated dicarboxylic acids, and monoesters of unsaturated dicarboxylic acids including monomethyl maleate, monoethyl maleate, monobutyl maleate, monomethyl fumarate, monoethyl fumarate, monomethyl itaconate, monoethyl itaconate and monobutyl itaconate; (meth)acrylate monomers, such as methyl (meth)acrylate, ethyl (meth)acrylate, n-butyl (meth)acrylate, t-butyl (meth)acrylate, 2-ethylhexyl (meth)acrylate, stearyl (meth)acrylate, phenyl (meth)acrylate, isobornyl (meth)acrylate, cyclohexyl (meth)acrylate, benzyl (meth)acrylate and 2-hydroxyethyl (meth)acrylate; (meth)acrylamide monomers, such as acrylamide, substituted acrylamide, methacrylamide and substituted methacrylamide; maleimide monomers, such as N-phenyl maleimide and N-cyclohexyl maleimide; styrene monomers, such as styrene and α-methyl styrene; ethylenically unsaturated monoolefin monomers, such as ethylene, propylene and isobutylene; vinyl ether monomers, such as vinyl methyl ether, vinyl ethyl ether and vinyl isobutyl ether; vinyl ketone monomers, such as vinyl methyl ketone; N-vinyl monomers, such as N-vinyl carbazole and N-vinyl pyrrolidone; and vinyl naphthalene salts. A part of or the whole of the carboxyl groups of the carboxyl-group-containing monomers can be neutralized during or after the polymerization. Acrylic acids and methacrylic acids can be collectively referred to as (meth)acrylic acids. The word, (meth)acrylate, means acrylate or methacrylate and the word, (meth)acryl, means acryl or methacryl. One of or a combination of at least two of the uncross-linkable monomers can be used.

The amount of the uncross-linkable monomer in the polymerizable component is not specifically restricted and preferably ranges from 90 to 100 wt %. The polymerizable component containing at least 90 wt % of the uncross-linkable monomer tends to be manufactured into lightweight hollow particles. The lower limit of the amount preferably is 93 wt %, more preferably 95 wt %, further more preferably 97 wt %, and most preferably 98 wt %. On the other hand, the upper limit of the amount preferably is 99.9 wt %, more preferably 99.8 wt %, further more preferably 99.7 wt %, and most preferably 99.6 wt %. Thus the amount preferably ranges from 95 to 99.8 wt % and more preferably from 97 to 99.6 wt %.

The polymerizable component containing a nitrile monomer as the uncross-linkable monomer is preferable for improved gas-barrier effect of the resultant thermoplastic resin to prevent the leakage of a gasified blowing agent in the heat-expandable microspheres during their thermal expansion and enable the manufacture of lightweight hollow particles. Furthermore, the resultant hollow particles retain the blowing agent in their hollow portions to have high internal pressure. The high internal pressure supports the thin shell of the hollow particles and resists the deformation of the hollow particles against a high pressure load.

The amount of the nitrile monomer in the uncross-linkable monomer is not specifically restricted and preferably ranges from 30 to 100 wt %. The lower limit of the amount preferably is 40 wt %, more preferably 50 wt %, further more preferably 60 wt %, and most preferably 70 wt %. On the other hand, the upper limit of the amount preferably is 98 wt %, more preferably 95 wt %, and further more preferably 90 wt %. Thus the amount preferably ranges from 40 to 98 wt % and more preferably from 50 to 95 wt %.

The uncross-linkable monomer containing acrylonitrile (hereinafter also referred to as AN) as the nitrile monomer is preferable for improving the gas barrier effect and rigidity of the shell of the resultant heat-expandable microspheres. Thus, the hollow particles manufactured from the heat-expandable microspheres have a shell that is not ruptured by a high pressure load and are more durable against deformation. The improved rigidity of the shell makes the hollow particles more durable against stress and friction to which the hollow particles are subjected when mixed with a base component. The acrylonitrile also improves the solvent resistance of the shell of the resultant heat-expandable microspheres, and the hollow particles manufactured from the heat-expandable microspheres can be used with organic solvents with less restriction.

The amount of acrylonitrile in the uncross-linkable monomer is not specifically restricted and preferably ranges from 25 to 100 wt %. The lower limit of the amount preferably is 40 wt %, more preferably 50 wt %, further more preferably 60 wt %, and most preferably 65 wt %. On the other hand, the upper limit of the amount preferably is 97 wt %, more preferably 92 wt %, and further more preferably 87 wt %. Thus the amount preferably ranges from 40 to 97 wt % and more preferably from 50 to 92 wt %.

The uncross-linkable monomer containing acrylonitrile in an amount within the range mentioned above is advantageous to make an organic silicon compound easily dissolve in the acrylonitrile so as to obtain heat-expandable microspheres in which the organic silicon compound exists below the outside surface of their shell. Furthermore, the uncross-linkable monomer containing at least 60 wt % of acrylonitrile facilitates the precipitation of the polyacrylonitrile polymer, which is generated in oily droplets (particles) in polymerization process, from the polymerizable component containing acrylonitrile to make the organic silicon compound tend to exist on the inside surface of the shell of het-expandable microspheres and/or to be encapsulated in the shell.

The nitrile monomer containing acrylonitrile and methacrylonitrile (hereinafter also referred to as MAN) is preferable for improving the denseness of the shell of the resultant heat-expandable microspheres to prevent the leakage of a gasified blowing agent in the microspheres during their thermal expansion and enable the manufacture of lightweight hollow particles. Furthermore, the resultant hollow particles retain the blowing agent in their hollow portions to have a high internal pressure. The high internal pressure supports the thin shell of the hollow particles and resists the deformation of the hollow particles against a high pressure load.

The weight ratio of AN and MAN contained in the uncross-linkable monomer is not specifically restricted and preferably ranges from 20:80 to 99:1 of AN and MAN. The weight ratio within the range mentioned above attains sufficient the denseness of the shell of the heat-expandable microspheres, and the hollow particles manufactured from the heat-expandable microspheres are lightweight enough and prevent their shell from deformation due to a high pressure load. The lower limit of the weight ratio preferably is 35:65, more preferably 50:50, and further more preferably 65:35. On the other hand, the upper limit of the weight ratio preferably is 95:5, more preferably 90:10, and further more preferably 85:15. Thus the weight ratio preferably ranges from 35:65 to 95:5 and more preferably from 50:50 to 90:10.

The uncross-linkable monomer containing (meth)acrylate ester monomer makes the thermoplastic resin constituting the shell of heat-expandable microspheres highly drawable in its heating and softening process and imparts the resin sufficient toughness. The hollow particles manufactured from the heat-expandable microspheres are lightweight and can prevent deformation of their shell against a high pressure load.

The amount of the (meth)acrylate ester monomer in the uncross-linkable monomer is not specifically restricted and preferably ranges from 0.2 to 50 wt %. The lower limit of the amount preferably is 0.5 wt %, and more preferably 1 wt %. On the other hand, the upper limit of the amount preferably is 40 wt %, more preferably 30 wt %, and further more preferably 20 wt %. Thus the amount preferably ranges from 0.5 to 40 wt % and more preferably from 1 to 30 wt %.

The uncross-linkable monomer containing a carboxyl-group-containing monomer is preferable to improve the heat resistance of the resultant heat-expandable microspheres. The sufficient heat-resistance contributes to efficiently increased strength and hardness of the heat-treated organic silicon compound, and the hollow particles manufactured from the heat-expandable microspheres prevent deformation of their shell against a high pressure load.

The amount of the carboxyl-group-containing monomer in the uncross-linkable monomer is not specifically restricted and preferably ranges from 5 to 70 wt %. The amount of the carboxyl-group-containing monomer within the range mentioned above contributes to improved rigidity of the shell of the heat-expandable microspheres, and the hollow particles manufactured from the heat-expandable microspheres prevent deformation of their very thin shell against a high pressure load. The lower limit of the amount preferably is 10 wt %, and the upper limit of the amount preferably is 60 wt %, more preferably 50 wt %, and further more preferably 40 wt %. Thus the amount preferably ranges from 5 to 60 wt % and more preferably from 10 to 50 wt %.

The total amount of the nitrile monomer and carboxyl-group-containing monomer in the uncross-linkable monomer is not specifically restricted and preferably ranges from 50 to 100 wt % and more preferably from 60 to 100 wt %. The uncross-linkable monomer containing at least 50 wt % of the total amount of the nitrile monomer and carboxyl-group-containing monomer contributes to the high gas-barrier effect, sufficient heat resistance and rigidity of the shell of the resultant heat-expandable microspheres, and the hollow particles having very thin shell manufactured from the heat-expandable microspheres are lightweight and highly heat resistant and prevent deformation against a high pressure load.

The amount of the carboxyl-group-containing monomer in the total amount of the nitrile monomer and carboxyl-group-containing monomer is not specifically restricted and preferably ranges from 5 to 70 wt %. The amount of the carboxyl-group-containing monomer within the range mentioned above contributes to improved rigidity of the shell of heat-expandable microspheres, and the hollow particles having very thin shell manufactured from the heat-expandable microspheres prevent deformation against a high pressure load. The lower limit of the amount preferably is 10 wt %. On the other hand, the upper limit of the amount preferably is 60 wt %, more preferably 50 wt %, and further more preferably 40 wt %. Thus the amount preferably ranges from 5 to 60 wt % and more preferably from 10 to 50 wt %.

The heat-expandable microspheres manufactured from a polymerizable component in which the uncross-linkable monomer contains carboxyl-group-containing monomer can be surface-treated with an organic compound containing a metal of the Groups 3 to 12 in the Periodic table or can contain cross-linkage of carboxyl groups and metal ions in order to increase the rigidity of the shell of the heat-expandable microspheres, and the hollow particles manufactured from the heat-expandable microspheres prevent deformation of their shell against a high pressure load.

The organic compound containing a metal of the Groups 3 to 12 in the Periodic table includes a compound having at least one chemical bond represented by formula (5) and/or a metal-amino acid compound.

M-O—C (5)

where M is a metal of Groups 3 to 12 in the Periodic table, and the carbon atom, C, binds with the oxygen atom, O, and binds only a hydrogen atom and/or carbon atom other than the oxygen atom.

The metal of the Groups 3 to 12 in the Periodic table includes, for example, the Group 3 metals such as scandium, ytterbium and cerium; the Group 4 metals, such as titanium, zirconium and hafnium; the Group 5 metals, such as vanadium, niobium and tantalum; the Group 6 metals, such as chromium, molybdenum and tungsten; the Group 7 metals, such as manganese and rhenium; the Group 8 metals such as iron, ruthenium and osmium; the Group 9 metals, such as cobalt and rhodium; the Group 10 metals, such as nickel and palladium; the Group 11 metals such as copper, silver and gold; and the Group 12 metals, such as zinc and cadmium. The classification of the metals described above is based on the “Periodic Table of Elements (2005)©, Atomic Weight Sub-Committee of The Chemical Society of Japan, 2006”, which was bound at the end of “Kagaku-to Kyoiku (Chemistry and Education) vol. 54, No. 4, 2006”.

The metal ions constituting the cross-linkage should preferably be a divalent or polyvalent metal cations, wherein the metal ions can include Al, Ca, Mg, Fe, Fe, Ti, Cu and Zn.

The polymerizable component can contain a cross-linkable monomer as mentioned above. The polymerizable component containing a cross-linkable monomer is preferable for improving denseness and rigidity of the shell of heat-expandable microspheres, and the hollow particles manufactured from the heat-expandable microspheres prevent deformation of their very thin shell against a high pressure load.

The cross-linkable monomer is not specifically restricted and includes, for example, alkane diol di(meth)acrylates, such as ethylene glycol di(meth)acrylate, 1,4-butanediol di(meth)acrylate, 1,6-hexanediol di(meth)acrylate, 1,9-nonanediol di(meth)acrylate, 1,10-decanediol di(meth)acrylate, neopentylglycol di(meth)acrylate, 3-methyl-1,5 pentanediol di(meth)acrylate and 2-methyl-1,8 octanediol di(meth)acrylate; polyalkylene glycol di(meth)acrylates, such as diethylene glycol di(meth)acrylate, triethylene glycol di(meth)acrylate, PEG (200) di(meth)acrylate, PEG (400) di(meth)acrylate, PEG (600) di(meth)acrylate, PEG (1000) di(meth)acrylate, dipropylene glycol di(meth)acrylate, tripropylene glycol di(meth)acrylate, polypropylene glycol (400) di(meth)acrylate, polypropylene glycol (700) di(meth)acrylate, polytetramethylene glycol di(meth)acrylate, polytetramethylene glycol (650) di(meth)acrylate and ethoxylated polypropylene glycol (700) di(meth)acrylate; and bifunctional, trifunctional, tetrafunctional or other polyfunctional cross-linkable monomers, such as ethoxylated bisphenol A di(meth)acrylate (with 2 to 30 moles of EO), propoxylated bisphenol A di(meth)acrylate, propoxylated ethoxylated bisphenol A di(meth)acrylate, glycerin di(meth)acrylate, polybutadiene di(meth)acrylate, polyisoprene di(meth)acrylate, 2-hydroxy-3-acryloyloxypropyl methacrylate, dimethylol-tricyclodecane di(meth)acrylate, divinylbenzene, ethoxylated glycerin triacrylate, 1,3,5-tri(meth)acryloylhexahydro-1,3,5-triazine, triaryl isocyanurate, pentaerythritol tri(meth)acrylate, trimethylolpropane tri(meth)acrylate, 1,2,4-trivinyl benzene, ditrimethylolpropane tetra(meth)acrylate, pentaerythritol tetra(meth)acrylate and dipentaerythritol hexa(meth)acrylate. One of or a combination of at least two of the cross-linkable monomers can be used.

The amount of the cross-linkable monomer in the polymerizable component is not specifically restricted and preferably ranges from 0.1 to 10 wt %. The polymerizable component containing at least 0.1 wt % of a cross-linkable monomer tend to attain sufficient rigidity of the shell of heat-expandable microspheres, and the hollow particles manufactured from the heat-expandable microspheres prevent deformation against a high pressure load. On the other hand, an amount of the cross-linkable monomer of 10 wt % or lower contributes to the manufacture of lightweight hollow particles. The lower limit of the amount of the cross-linkable monomer preferably is 0.2 wt %, more preferably 0.3 wt %, and further more preferably 0.4 wt %. On the other hand, the upper limit of the amount of the cross-linkable monomer preferably is 7 wt %, more preferably 5 wt %, further more preferably 3 wt % and most preferably 2 wt %. Thus the amount preferably ranges from 0.2 to 5 wt % and more preferably from 0.4 to 3 wt %.

The blowing agent which gasifies by heating is encapsulated in the shell of heat-expandable microspheres and makes the whole of a microsphere thermally expandable (a microsphere wholly expandable by heating).

The blowing agents include, for example, C₁-C₁₃ hydrocarbons such as methane, ethane, propane, (iso)butane, (iso)pentane, (iso)hexane, (iso)heptane, (iso)octane, (iso)nonane, (iso)decane, (iso)undecane, (iso)dodecane and (iso)tridecane; hydrocarbons having a carbon number greater than 13 and not greater than 20, such as (iso)hexadecane and (iso)eicosane; hydrocarbons from petroleum fractions such as pseudocumene, petroleum ether, and normal paraffins and isoparaffins having an initial boiling point ranging from 150° C. to 260° C. and/or being distilled at a temperature ranging from 70° C. to 360° C.; halides of C₁₋₁₂ hydrocarbons, such as methyl chloride, methylene chloride, chloroform and carbon tetrachloride; fluorine-containing compounds, such as hydrofluoroether; silanes having C₁-C₅ alkyl groups, such as tetramethyl silane, trimethylethyl silane, trimethylisopropyl silane and trimethyl-n-propyl silane; and compounds which thermally decompose to generate gases, such as azodicarbonamide, N,N′-dinitrosopentamethylenetetramine and 4,4′-oxybis(benzenesulfonyl hydrazide).

The blowing agent can be composed of one chemical compound or a mixture of at least two chemical compounds. The blowing agent can be any of linear, branched or cyclic compounds, and aliphatic compounds are preferable.

The hollow particles manufactured by expanding heat-expandable microspheres basically contain gasified blowing agent in their hollow portions, though a part of the blowing agent can remain in the cores in liquid or solid state.

The hollow particles preferably contain a blowing agent having a vapor pressure of at least 100 kPa at 25° C., a temperature conceivable in general use, in order to retain high internal pressure and resist their deformation against a high pressure load even if they have very thin shell. Thus the heat-expandable microspheres preferably contain a blowing agent having a vapor pressure of at least 100 kPa at 25° C.

The chemical compound having a vapor pressure higher than 100 kPa at 25° C. includes, for example, methyl chloride, methane, ethane, propane and (iso)butane, and isobutane is preferable. Isobutane used as a blowing agent having a vapor pressure higher than 100 kPa at 25° C. contributes to manufacture of lightweight hollow particles and retains a high internal pressure of the hollow portions of the hollow particles. This is because isobutane is not apt to escape from the shell of the hollow particles. Thus, such hollow particles have a high repulsion force against a high external pressure load and prevent deformation of their shell.

The blowing agent can contain one or a combination of at least two of compounds having a vapor pressure higher than 100 kPa at 25° C.

The amount of the compound having a vapor pressure higher than 100 kPa at 25° C. in a blowing agent is not specifically restricted and preferably ranges from 10 wt % to 100 wt %. A blowing agent containing at least 10 wt % of a compound having a vapor pressure higher than 100 kPa at 25° C. results in a high internal pressure of the hollow portion of the hollow particles manufactured from the resultant expandable microspheres, and such hollow particles have a high repulsion force against a high external pressure load and prevent the deformation of their shell. The lower limit of the amount of the compound having a vapor pressure higher than 100 kPa at 25° C. preferably is 35 wt %, and more preferably 40 wt %. On the other hand, the upper limit of the amount of the compound having a vapor pressure higher than 100 kPa at 25° C. preferably is 99 wt %. Thus the amount preferably ranges from 35 to 100 wt % and more preferably from 40 to 99 wt %.

The encapsulation ratio of a blowing agent in heat-expandable microspheres of the present invention is defined as the weight percentage of the blowing agent encapsulated in the heat-expandable microspheres to the weight of the heat-expandable microspheres.

The encapsulation ratio of the blowing agent is not specifically restricted and preferably ranges from 2 wt % to 35 wt %. The encapsulation ratio within the above range attains a high internal pressure of the heat-expandable microspheres during thermal expansion and prevents the leakage of the blowing agent to result in the manufacture of lightweight hollow particles. The lower limit of the encapsulation ratio preferably is 4 wt %, more preferably 5 wt %, and further more preferably 6 wt %. On the other hand, the upper limit of the encapsulation ratio preferably is 25 wt %, more preferably 20 wt %, and further more preferably 15 wt %. Thus the encapsulation ratio preferably ranges from 4 to 25 wt % and more preferably from 5 to 20 wt %.

The expansion-starting temperature (Tₛ) of the heat-expandable microspheres is not specifically restricted and preferably ranges from 90 to 250° C. for attaining the effect of the present invention. The lower limit of the expansion-starting temperature preferably is (1) 100° C., (2) 110° C., (3) 120° C., (4) 130° C., and (5) 110° C. (where a greater number in the parentheses indicates a more preferable lower limit). On the other hand, the upper limit of the expansion-starting temperature preferably is 250° C., more preferably 220° C., further more preferably 200° C., and yet further more preferably 190° C. Thus the expansion-starting temperature preferably ranges from 100 to 250° C., more preferably from 120 to 200° C., and yet more preferably from 130 to 190° C.

The maximum expansion temperature (Tₘₐₓ) of the heat-expandable microspheres of the present invention is not specifically restricted, and preferably is at least 150° C., more preferably at least 180° C., and yet more preferably at least 200° C. for increasing the strength and hardness of the heat-treated organic silicon compound. The upper limit of the temperature preferably is 300° C. Thus, the maximum expansion temperature preferably ranges from 150 to 300° C. and more preferably from 180 to 300° C.

The expansion-starting temperature (Tₛ) and maximum expansion temperature (Tₘₐₓ) of the heat-expandable microspheres of the present invention are measured by the method described in the Examples.

The mean volume particle size (herein also referred to as mean particle size) of the heat-expandable microspheres of the present invention is not specifically restricted and preferably ranges from 5 to 80 μm. Heat-expandable microspheres having a mean particle size of at least 5 μm tend to produce a hollow particles with resisted deformation of their shell. On the other hand, heat-expandable microspheres having a mean particle size of 80 μm or smaller have shell of uniform thickness which prevents the leakage of blowing agent, and such heat-expandable microspheres tend to produce lightweight hollow particles. The lower limit of the mean particle size preferably is 10 μm and more preferably 15 μm. On the other hand, the upper limit of the mean particle size preferably is 70 μm and more preferably 60 μm. Thus the mean particle size preferably ranges from 10 to 70 μm, and more preferably from 15 to 60 μm.

The mean volume particle size of the heat-expandable microspheres of the present invention are measured by the method described in the Examples.

The coefficient of variation, CV, of the particle size distribution of the heat-expandable microspheres of the present invention is not specifically restricted, and preferably is not greater than 40%, more preferably not greater than 35%, yet more preferably not greater than 30%, and most preferably not greater than 25%.

The coefficient of variation, CV, can be calculated by the following formulae (1) and (2).

$$[ Formulae 1 ]$$

$$CV = ( s / < x > ) \times 100 ( \% ) \qquad ( 1 )$$

$$s = {\{ {\sum }_{i = 1}^{n} {( xi - < x > )}^{2} / ( n - 1 ) \}}^{1 / 3} \qquad ( 2 )$$

(where “s” is a standard deviation of the particle size of the microspheres, <x> is a mean particle size of the microspheres, “xi” is the particle size of the i-th particle, and “n” represents the number of particles).

The maximum volumetric expansion ratio of the heat-expandable microspheres of the present invention is not specifically restricted and preferably ranges from 5 times to 200 times of the original volume. Heat-expandable microspheres expandable to 5 times or more tend to produce lightweight hollow particles. On the other hand, heat-expandable microspheres expandable to 200 times or less tend to produce hollow particles having the shell of improved rigidity to resist the deformation of the hollow particles against a high external pressure load. The lower limit of the volumetric expansion ratio preferably is 10 times and more preferably 13 times. On the other hand, the upper limit of the volumetric expansion preferably is 180 times and more preferably 150 times. Thus the volumetric expansion ratio preferably ranges from 10 times to 180 times and more preferably from 13 times to 150 times.

The heat-expandable microspheres of the present invention have high durability against a high pressure load. Thus, the heat-expandable microspheres can be preferably applied for the materials processed in molding, such as injection molding, extrusion molding, successively operated kneading and molding, calendaring, blow molding, compression molding, vacuum molding and thermal molding, and also used by combining with pastes including vinyl chloride pastes and liquid compositions including EVA emulsions, acrylate emulsions and urethane binders.

### Process for Producing Heat-Expandable Microspheres

The process for producing the heat-expandable microspheres of the present invention includes the step of dispersing an oily mixture which contains a polymerizable component, a blowing agent, an organic silicon compound, and a polymerization initiator in an aqueous dispersion medium and polymerizing the polymerizable component (hereinafter also referred to as the polymerization step).

Another process for producing the heat-expandable microspheres includes the step of polymerizing a polymerizable component by dispersing an oily mixture containing the polymerizable component, a blowing agent, and a polymerization initiator in an aqueous dispersion medium (hereinafter also referred to as the intermediate polymerization step) and the step of mixing the intermediate of heat-expandable microspheres (hereinafter also referred to as the intermediate) obtained in the intermediate polymerization step and an organic silicon compound (hereinafter also referred to as the organic silicon compound mixing step). In this process, the oily mixture can contain the organic silicon compound.

The polymerization initiator is not specifically restricted, and includes peroxides and azo compounds.

The peroxides include, for example, peroxidicarbonates, such as diisopropyl peroxydicarbonate, di-sec-butyl peroxydicarbonate, di-2-ethylhexyl peroxydicarbonate and dibenzyl peroxydicarbonate; diacyl peroxides, such as dilauroyl peroxide and dibenzoyl peroxide; ketone peroxides, such as methyl ethyl ketone peroxide and cyclohexanone peroxide; peroxy ketals, such as 2,2-bis(t-butylperoxy) butane; hydroperoxides, such as cumene hydroperoxide and t-butyl hydroperoxide; dialkyl peroxides, such as dicumyl peroxide and di-t-butyl peroxide; and peroxyesters, such as t-hexyl peroxypivalate and t-butyl peroxyisobutylate.

The azo compound includes, for example, 2,2′-azobis(4-methoxy-2,4-dimethyl valeronitrile), 2,2′-azobisisobutylonitrile, 2,2′-azobis(2,4-dimethyl valeronitrile), 2,2′-azobis(2-methyl propionate), 2,2′-azobis(2-methyl butylonitrile) and 1,1′-azobis(cyclohexane-1-carbonitrile).

The amount of the polymerization initiator is not specifically restricted and preferably ranges from 0.05 to 10 parts by weight to 100 parts by weight of the polymerizable component, more preferably from 0.1 to 8 parts by weight, and most preferably from 0.2 to 5 parts by weight. An amount of the polymerization initiator less than 0.05 parts by weight can leave some of the polymerizable component unpolymerized, and the resultant heat-expandable microspheres can have a shell without sufficient rigidity and elasticity. Consequently, the shell of the hollow particles manufactured from such heat-expandable microspheres can deform due to high pressure. On the other hand, an amount more than 10 parts by weight can impair the expansion performance of the resultant heat-expandable microspheres and such microspheres cannot produce lightweight hollow particles. One of or a combination of at least two of the polymerization initiator can be used.

The aqueous dispersion medium used in the (intermediate) polymerization step contains water, such as deionized water, as the main component, the oily mixture is dispersed therein. The aqueous dispersion medium can further contain alcohols, such as methanol, ethanol and propanol, and hydrophilic organic solvents, such as acetone. The hydrophilic property mentioned in the present invention means the property of a substance optionally miscible in water. In the present invention, the (intermediate) polymerization step means the polymerization step or the intermediate polymerization step.

The amount of the aqueous dispersion medium used in the process is not specifically restricted, and preferably ranges from 100 to 1000 parts by weight to 100 parts by weight of the polymerizable component.

The aqueous dispersion medium can further contain an electrolyte, such as sodium chloride, magnesium chloride, calcium chloride, sodium sulfate, magnesium sulfate, ammonium sulfate and sodium hydroxide. One of or a combination of at least two of these electrolytes can be used.

The content of the electrolyte is not specifically restricted, and preferably ranges from 0.1 to 50 parts by weight to 100 parts by weight of the aqueous dispersion medium.

The aqueous dispersion medium can contain at least one water-soluble compound selected from among polyalkylene imines having a nitrogen atom bonded with an alkyl group substituted with a hydrophilic functional group selected from carboxylic acid (salt) groups and phosphonic acid (salt) groups, water-soluble 1,1-substitution compounds having a carbon atom bonded with a hetero atom and with a hydrophilic functional group selected from hydroxyl group, water-soluble ascorbic acids, water-soluble polyphenols, water-soluble vitamin Bs, potassium dichromate, alkali metal nitrite salts, metal (III) halides, boric acid, and water-soluble phosphonic acids (phosphonate salts). The term “water-soluble” in the present invention means that at least 1 g of a substance is soluble in 100 g of water.

The amount of the water-soluble compound contained in the aqueous dispersion medium is not specifically restricted, and preferably ranges from 0.0001 to 1.0 part by weight to 100 parts by weight of the polymerizable component, more preferably from 0.0003 to 0.1 part by weight, and most preferably from 0.001 to 0.05 parts by weight.

The aqueous dispersion medium can contain a dispersion stabilizer and dispersion stabilizing auxiliary in addition to the electrolytes and water-soluble compounds.

The dispersion stabilizer includes, for example, calcium triphosphate, magnesium pyrophosphate and calcium pyrophosphate produced by double decomposition reaction, colloidal silica, alumina sol and magnesium hydroxide. One of or a combination of at least two of those dispersion stabilizers can be used.

The amount of the dispersion stabilizer is not specifically restricted and preferably ranges from 0.05 to 100 parts by weight to 100 parts by weight of the polymerizable component and more preferably from 0.2 to 70 parts by weight.

The dispersion stabilizing auxiliary includes, for example, polymeric dispersion stabilizing auxiliaries, and surfactants, such as cationic surfactants, anionic surfactants, amphoteric surfactants and nonionic surfactants. One of or a combination of at least two of those dispersion stabilizing auxiliaries can be used.

The aqueous dispersion medium is prepared, for example, by optionally selecting and blending electrolytes, water-soluble compounds, dispersion stabilizers and dispersion stabilizing auxiliaries to water (deionized water). The pH of the aqueous dispersion medium for the polymerization process is adjusted according to the water-soluble compounds, dispersion stabilizers and dispersion stabilizing auxiliaries.

In the (intermediate) polymerization step, the polymerizable component can be polymerized in the presence of sodium hydroxide or in the presence of sodium hydroxide and zinc chloride.

In the (intermediate) polymerization step, the oily mixture is dispersed and suspended in the aqueous dispersion medium to be formed into oil globules of a prescribed particle size.

The methods for dispersing and suspending the oily mixture include generally known dispersion methods, such as agitation with a Homo-mixer (for example, a device manufactured by Primix Corporation), dispersion with a static dispersing apparatus such as a Static mixer (for example, a device manufactured by Noritake Engineering Co., Ltd.), membrane emulsification technique and ultrasonic dispersion.

Then suspension polymerization is started by heating the dispersion in which the oily mixture is dispersed into oil globules in the aqueous dispersion medium. During the polymerization reaction, the dispersion should preferably be agitated gently to prevent floating of monomers and sedimentation of polymerized heat-expandable microspheres.

The polymerization temperature can be set optionally depending on the type of the polymerization initiator, and preferably is controlled within the range of from 30 to 90° C. and more preferably from 40 to 88° C. The polymerization temperature preferably is maintained for about 1 to 20 hours. The initial pressure for the polymerization is not specifically restricted, and preferably is controlled within the range of from 0 to 5 MPa in gauge pressure and more preferably from 0.2 to 3 MPa.

The slurry obtained in (intermediate) polymerization step is filtered with a centrifugal separator, press filter or suction extractor to be processed into wet cake with a water content ranging from 10 to 50 wt %, preferably from 15 to 45 wt % and more preferably from 20 to 40 wt %. The cake is dried in a tray drier, indirect heating oven, fluidized bed dryer, vacuum dryer, vibration dryer or flash dryer to be prepared into dry powder with a moisture content preferably be not greater than 5 wt %, more preferably not greater than 3 wt %, and further more preferably not greater than 1 wt %.

The cake can be washed with water and/or redispersed in water and then filtered again before the drying step for the purpose of decreasing the content of the ionic substances. The slurry can also be dried with a spray dryer or fluidized bed dryer to be processed into dry powder.

In the organic silicon compound mixing step, the intermediate produced in the intermediate polymerization step mentioned above is mixed with an organic silicon compound. In this step, an organic silicon compound exists on the outside surface of the shell of heat-expandable microspheres.

The intermediate for the organic silicon compound mixing step can be in the state of either slurry, wet cake or dry powder.

The organic silicon compound mixing step includes the steps 1) to 4) mentioned below.
1) Mixing the dry powder or wet cake of the intermediate, an organic silicon compound, and water or volatile liquid, such as alcohol; and spraying the mixture with a sprayer followed by drying operation.
2) Mixing the slurry of the intermediate and an organic silicon compound, and spraying the mixture with a sprayer followed by drying operation.
3) Mixing the wet cake or slurry of the intermediate and an organic silicon compound, and dehydrating the mixture followed by drying operation.
4) Mixing the dry power of the intermediate and an organic silicon compound with a mixer.

In the organic silicon compound mixing step, the mixture can be heated at a temperature lower than the expansion-starting temperature of the intermediate.

The device for the organic silicon compound mixing step can be any of known devices which are generally used for shaking or agitation.

### Hollow Particles

The hollow particles of the first embodiment of the present invention are manufactured by thermally expanding the heat-expandable microspheres mentioned above.

The hollow particles of the first embodiment of the present invention are manufactured by thermally expanding the heat-expandable microspheres mentioned above, and a heat-treated organic silicon compound exists on the outside surface and/or below the outside surface of the shell of the hollow particles to resist the deformation of the shell against a high pressure load. “The heat-treated organic silicon compound existing below the outside surface of the shell of the hollow particles” means at least one of the states of the heat-treated organic silicon compound “existing within the shell of the hollow particles”, “existing on the inside surface of shell of the hollow particles” and “existing in the hollow portion of the hollow particles surrounded by the shell”.

The hollow particles of the second embodiment of the present invention comprise a shell containing a thermoplastic resin, a hollow portion surrounded by the shell, and an organic silicon compound. The organic silicon compound exists below the outside surface of the shell and/or on the outside surface of the shell. The organic silicon compound contains at least one unit selected from among T unit which is a siloxane unit represented by R¹SiO_{3/2} and D unit which is a siloxane unit represented by R²₂SiO_{2/2} wherein each R¹ and R² is a monovalent organic group having 1 to 15 carbon atoms. In the present invention, “the organic silicon compound existing below the outside surface of the shell of the hollow particles” means at least one of the states of the organic silicon compound “existing within the shell of the hollow particles”, “existing on the inside surface of shell of the hollow particles” and “existing in the hollow portion of the hollow particles surrounded by the shell”.

The organic silicon compound existing at least one position selected from the positions on the outside surface of the shell, in the shell, and the inside surface of the shell of the hollow particles of the second embodiment of the present invention supports the shell of the hollow particles and resists the deformation of the shell of the hollow particles of the shell, such as rupture or dent, against high pressure load.

The hollow particles of the second embodiment of the present invention can be the hollow particles of the first embodiment, and the organic silicon compound contained in the hollow particles can be a heated product (heat-treated product).

The hollow particles of the present invention are lightweight and impart good material properties to a composition or formed product.

The organic silicon compound contained in the hollow particles of the second embodiment of the present invention can be identified by analyzing the cross section of a hollow particles in elemental analysis techniques, such as wavelength dispersive X-ray spectroscopy (WDX) with an electron probe micro analyzer (EPMA) and energy dispersive X-ray spectroscopy (EDX) with a Scanning electron microscope (SEM).

The hollow particles of the second embodiment of the present invention are not specifically restricted and preferably comprise the organic silicon compound below the outside surface or on the outside surface of the hollow particles and more preferably below the outside surface of the hollow particles.

The organic silicon compound contained in the hollow particles of the second embodiment of the present invention contains at least one structural unit selected from among T unit represented by R¹SiO_{3/2} and D unit represented by R²₂SiO_{2/2}, wherein each of R¹ of T unit and R² of D unit is a monovalent organic group having 1 to 15 carbon atoms.

R¹ and R² are not specifically restricted and preferably are a hydrocarbon group. The hydrocarbon group includes, for example, alkyl groups, such as methyl group, ethyl group and propyl group, and aromatic groups such as phenyl group. R¹ and R² can have cyclic structure, such as aromatic ring. R¹ and R² can be the same or different.

The content of the phenyl groups in R¹ and R² is not specifically restricted and preferably ranges from 0 to 60 mol % to 1 mol of the organic silicon compound, more preferably from 0 to 40 mol %, and further more preferably from 0 to 20 mol %. The content of the phenyl groups within above-mentioned the range results in increased strength and hardness of the organic silicon compound to efficiently resist deformation of the shell of the hollow particles.

The content of the alkyl groups in R¹ and R² is not specifically restricted and preferably ranges from 40 to 100 mol % to 1 mol of the organic silicon compound, more preferably from 60 to 100 mol %, and further more preferably from 80 to 100 mol %. The content of the alkyl groups within the above-mentioned range results in increased strength and hardness of the organic silicon compound to efficiently resist deformation of the shell of the hollow particles.

The total amount of the T units and D units in the entire units constituting the organic silicon compound contained in the hollow particles of the second embodiment of the present invention is not specifically restricted and preferably ranges from 40 to 100%, more preferably from 50 to 100%, further more preferably from 60 to 100%, and yet further more preferably from 70 to 100%. The amount of at least 40% attains the network structure of the organic silicon compound to increase its strength and resist deformation of the shell of the hollow particles. The preferable amount of T units or D units in the entire number of the units constituting the organic silicon compound is within the above-mentioned range.

The embodiment of the organic silicon compound is not specifically restricted and an organic silicon compound containing T units is preferable for attaining the effect of the present invention.

The content of the organic silicon compound in the hollow particles of the second embodiment of the present invention is not specifically restricted and preferably ranges from 0.05 to 50 parts by weight to 100 parts by weight of hollow particles. Hollow particles containing at least 0.05 parts by weight of the organic silicon compound have a shell of increased strength to resist their deformation. On the other hand, hollow particles containing 50 parts by weight or less of the organic silicon compound are lightweight. The lower limit of the content preferably is 0.1 parts by weight, more preferably 0.3 parts by weight, further more preferably 0.5 parts by weight, and most preferably 1 parts by weight. On the other hand, the upper limit of the content preferably is 35 parts by weight, more preferably 20 parts by weight, further more preferably 15 parts by weight, and most preferably 10 parts by weight. Thus the content preferably ranges from 0.1 to 35 parts by weight and further more preferably from 0.3 to 20 parts by weight.

The thermoplastic resin constituting the shell of the hollow particles of the second embodiment of the present invention is not specifically restricted and preferably is the polymer of the polymerizable component mentioned above.

The hollow particles of the first embodiment of the present invention basically contain gasified blowing agent in their hollow portions, though a part of the blowing agent in the hollow portions can be liquid or solid. In addition, the hollow portions of the hollow particles can contain the air introduced from external environment.

The blowing agent contained in the hollow portions of the hollow particles of the first embodiment of the present invention enables to keep high internal pressure of the hollow portions which becomes high repulsion force to internally support the shell of hollow particles against external high pressure to resist the deformation of their shell.

The hollow particles of the second embodiment of the present invention are not specifically restricted and preferably contain a gas of a thermally gasifiable chemical compound in their hollow portions. The hollow particles of the second embodiment of the present invention can contain a thermally gasifiable chemical compound, a part of which can be liquid or solid, and the air introduced from external environment in their hollow portions. The thermally gasifiable chemical compound can be the blowing agent mentioned above.

The encapsulation ratio of the thermally gasifiable chemical compound (blowing agent) in the hollow portions of the hollow particles of the present invention means the weight percentage of the thermally gasifiable chemical compound (blowing agent) to the weight of the hollow particles. The encapsulation ratio is defined as the ratio determined by the method described in the following Examples.

The encapsulation ratio is not specifically restricted and preferably ranges from 2 to 35 wt %. The encapsulation ratio within the above-mentioned range attains high internal pressure of the hollow portions and sufficient shell thickness of the hollow particles to prevent the deformation of the hollow particles under a high external pressure. The encapsulation ratio lower than 2 wt % cannot attain sufficient internal pressure of the hollow portions of the hollow particles and can cause the deformation of the shell of the hollow particles under high external pressure. The lower limit of the encapsulation ratio preferably is 4 wt %, and more preferably 5 wt %. On the other hand, the upper limit of the encapsulation ratio preferably is 28 wt %, more preferably 23 wt %, and further more preferably 18 wt %. Thus the encapsulation ratio preferably ranges from 4 to 28 wt % and more preferably from 5 to 23 wt %.

The mean volume particle size (hereinafter sometimes referred to as mean particle size) of the hollow particles of the present invention is not specifically restricted and can be freely designed according to their application. However, the mean particle size preferably ranges from 6 to 300 μm for resisting the deformation of the shell of the hollow particles. The hollow particles having a mean particle size of lower than 6 μm can have a thin shell which can be deformed under high external pressure. On the other hand, hollow particles having a mean particle size of greater than 300 μm can have a shell of nonuniform thickness which tend to cause the leakage of the thermally gasifiable chemical compound (blowing agent) and can be deformed under high external pressure. The lower limit of the mean particle size preferably is 10 μm, more preferably 15 μm, and further more preferably 20 μm. On the other hand the upper limit of the mean particle size preferably is 250 μm and more preferably 200 μm.

The mean volume particle size of the hollow particles is determined in the method described in the following Examples.

The coefficient of variation, CV, of the particle size distribution of the hollow particles of the present invention is not specifically restricted, and preferably is not greater than 35%, more preferably not greater than 30%, and yet more preferably not greater than 25%. The coefficient of variation, CV, of the hollow particles can be calculated by the formulae (1) and (2) mentioned above.

The true specific gravity of the hollow particles of the present invention is not specifically restricted and preferably ranges from 0.005 to 0.6. The hollow particles having a true specific gravity of lower than 0.005 have a thin shell which can be deformed under high external pressure. On the other hand, The hollow particles having a true specific gravity of higher than 0.6 have poor lightweight effect, and thus higher amount of the hollow particles is required to be added to a composition. Such high amount of the hollow particles in a composition can deteriorate the property of the composition and the resultant formed product. The lower limit of the true specific gravity preferably is 0.01, more preferably 0.015, and further more preferably 0.020. On the other hand, the upper limit of the true specific gravity preferably is 0.4, and more preferably 0.3.

The hollow particles of the present invention are, for example, manufactured from the heat-expandable microspheres mentioned above by thermally expanding the microspheres at a temperature preferably ranging from 100° C. to 450° C.

The thermal expansion process is not specifically restricted, and either dry thermal expansion or wet thermal expansion can be employed. An example of the dry thermal expansion is the method disclosed in Japanese Patent Application Publication 2006-213930, the content of which is incorporated herein by reference, specifically, the internal injection method. Another example of the dry thermal expansion is the method disclosed in Japanese Patent Application Publication 2006-96963, the content of which is incorporated herein by reference.

An example of the wet thermal expansion is the method disclosed in Japanese Patent Application Publication 1987-201231, the content of which is incorporated herein by reference.

### Fine-Particle-Coated Hollow Particles

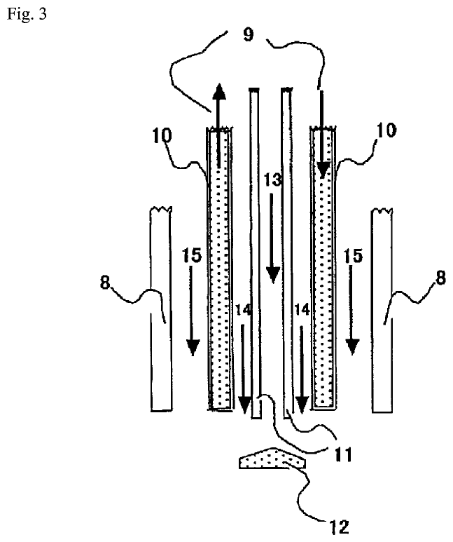

The fine-particle-coated hollow particles of the present invention comprise the hollow particles mentioned above and fine particle coating the outside surface of the shell of the hollow particles. As shown in FIG. 2, the fine-particle-coated hollow particles can comprise the fine particle (4 and 5) coating the outer surface of the shell (2) of a hollow particles (1). The coating mentioned herein means that the fine particles are in a state of adhesion (the state of the fine particle 4 in FIG. 2) on the outside surface of the shell 2 of a hollow particles, or in a state of fixation (the state of the fine particle 5 in FIG. 2) in a dent on the outside surface of the shell as the result of the fine particle embedding into the thermoplastic shell melted by heating.

The fine particles coating the hollow particles prevents scattering of the hollow particles to improve their handling property and improves their dispersibility in a base component, such as binders and resins.

The fine particles can be selected from various materials including both inorganic and organic materials.

The shape of the fine particles can be arbitrary or spherical. The shape of the fine particles includes, for example, spherical, needle-like and plate-like shapes.

The inorganic compounds for the fine particles are not specifically restricted, and include, for example, wollastonite, sericite, kaolin, mica, clay, talc, bentonite, aluminum silicate, pyrophyllite, montmorillonite, calcium silicate, calcium carbonate, magnesium carbonate, dolomite, calcium sulfate, barium sulfate, glass flake, boron nitride, silicon carbide, silica, alumina, isinglass, titanium dioxide, zinc oxide, magnesium oxide, hydrotalcite, carbon black, molybdenum disulfide, tungsten disulfide, ceramic beads, glass beads, crystal beads and glass microballoons.

The organic compounds for the fine particles include, for example, sodium carboxymethyl cellulose, hydroxyethyl cellulose, methyl cellulose, ethyl cellulose, nitro cellulose, hydroxypropyl cellulose, sodium alginate, polyvinyl alcohol, polyvinyl pyrrolidone, sodium polyacrylate, carboxyvinyl polymer, polyvinyl methyl ether, magnesium stearate, calcium stearate, zinc stearate, polyethylene wax, lauric amide, myristic amide, palmitic amide, stearic amide, hydrogenated castor oil, (meth)acrylic resin, polyamide resin, urethane resin, polyethylene resin, polypropylene resin and fluorine resin.

The inorganic and organic compounds for the fine particles can be surface-treated with a surface-treatment agent, such as a silane coupling agent, paraffin wax, fatty acid, resin acid, urethane compound and fatty acid ester, or cannot be surface-treated.

The mean particle size of the fine particles is not specifically restricted, and preferably ranges from 0.001 to 30 μm, more preferably from 0.005 to 25 μm, and most preferably from 0.01 to 20 μm. The mean particle size of the fine particles mentioned herein is the particle size of the fine particles determined by laser diffractometry.

The ratio of the particle size of the fine particles to the particle size of the hollow particles (the mean particle size of the fine particles/the mean volume particle size of the hollow particles) preferably is not higher than 1 for sufficiently coating the hollow particles with the fine particles, more preferably not higher than 0.1 and further more preferably not higher than 0.05.

The amount of the fine particles contained in the fine-particle-coated hollow particles is not specifically restricted, and preferably is not higher than 95 wt %, more preferably not higher than 90 wt %, further more preferably not higher than 85 wt % and yet further more preferably not higher than 80 wt %. The amount of the fine particles higher than 95 wt % can result in higher amount of the fine-particle-coated hollow particles required to be added to a composition and lead to increased cost. The lower limit of the amount preferably is 20 wt %, and more preferably 40 wt %.

The true specific gravity of the fine-particle-coated hollow particles of the present invention is not specifically restricted and preferably ranges from 0.06 to 0.60. The fine-particle-coated hollow particles having a true specific gravity of lower than 0.06 can have excessively a thin shell which deforms under high external pressure. On the other hand, the fine-particle-coated hollow particles having a true specific gravity of higher than 0.6 have poor lightweight effect, and thus higher amount of the fine-particle-coated hollow particles is required to be added to a composition. Such high amount of the fine-particle-coated hollow particles in a composition can deteriorate the property of the composition and the resultant formed product. The lower limit of the true specific gravity preferably is 0.1, and more preferably 0.12. On the other hand, the upper limit of the true specific gravity preferably is 0.3, and more preferably 0.2.

The hollow particles and fine-particle-coated particles of the present invention can have further expansion performance.

The further expansion performance means the property of the hollow particles and fine-particle-coated particles to further expand (re-expand) by heating.

The further expansion ratio of the hollow particles and fine-particle-coated hollow particles is not specifically restricted and preferably ranges from 5 to 85%. Hollow particles and fine-particle-coated hollow particles having a further expansion ratio lower than 5% can have poor performance of retaining the blowing agent encapsulated therein and have low repulsion force against external high pressure to cause the deformation of their shell under high external pressure. On the other hand, hollow particles and fine-particle-coated hollow particles having a further expansion ratio of higher than 85% indicates that the particles can fail to attain satisfactory lightweight effect. The lower limit of the further expansion ratio preferably is 10%, and more preferably 15%. On the other hand, the upper limit of the further expansion ratio preferably is 80%, and more preferably 70%.

The further expansion ratio of hollow particles and fine-particle-coated particles represents the degree of their re-expansion compared to the expansion of hollow particles manufactured by maximally expanding heat-expandable microspheres (hereinafter also referred to as maximally expanded hollow particles). The further expansion ratio is calculated by the following formulae from the true specific gravity of the hollow particles (d₂), the true specific gravity of the hollow particles contained in fine-particle-coated hollow particles (d₄), and the true specific gravity of the maximally expanded hollow particles (d₅).

Further expansion ratio of hollow particles (%)=(1−d₅/d₂)×100

Further expansion ratio of fine-particle-coated hollow particles (%)=(1−d₅/d₄)×100

The true specific gravity of hollow particles (d₂), the true specific gravity of the hollow particles contained in fine-particle-coated hollow particles (d₄), and the true specific gravity of the maximally expanded hollow particles (d₅) are determined in the methods described in the following Examples.

The fine-particle-coated hollow particles of the present invention are blended in the composition described below to be prepared into useful paint composition and adhesive composition.

The process for producing the fine-particle-coated hollow particles of the present invention includes, for example, a process containing a mixing step and a coating step described below.

Mixing step: the step of mixing heat-expandable microspheres and fine particles;

Coating step: the step of heating the mixture from the mixing step to a temperature higher than the softening point of the thermoplastic resin constituting the shell of the heat-expandable microspheres to expand the heat-expandable microspheres and coat the outer surface of the resultant hollow particles with the fine particles.

### Mixing Step

The heat-expandable microspheres and fine particles are mixed in the mixing step. The heat-expandable microspheres and the fine particles are those mentioned above.

In the mixing step, the amount of the fine particles in the total amount of the heat-expandable microspheres and the fine particles is not specifically restricted, and preferably is not higher than 95 wt %, more preferably not higher than 90 wt %, further more preferably not higher than 85 wt % and most preferably not higher than 80 wt %. The amount of the fine particles higher than 95 wt % can cause an excessively high true specific gravity of the resultant fine-particle-coated hollow particles to impair the lightweight effect of the particles.

The device used to mix the heat-expandable microspheres and fine particles in the mixing step is not specifically restricted, and a quite simple device, such as a combination of a vessel and stirring paddle, can be used. A common type of powder mixer which shakes and agitates powder materials can be used.

Such powder mixers include a ribbon mixer and vertical screw mixer which can shake and agitate or agitate powder materials. In addition, Super Mixer (manufactured by KAWATA MFG Co., Ltd.), High Speed Mixer (manufactured by Fukae Co., Ltd.), New-Gra Machine (manufactured by Seishin Enterprise Co., Ltd.) and SV Mixer (manufactured by Kobelco Eco-Solutions Co., Ltd.) mixers can be employed.

### Coating Step

In the coating step, the mixture of the heat-expandable microspheres and fine particles prepared in the mixing step is heated at a temperature higher than the softening point of the thermoplastic resin constituting the shell of the microspheres, and the heat-expandable microspheres are expanded and simultaneously coated with the fine particles on the outer surface of their shell.

The heat-expandable microspheres can be heated by a commonly used mixer dryer with a contact heating system or direct heating system.

The function of the mixer dryer is not specifically restricted, and the mixer dryer preferably has the function of dispersing and mixing powder material under a controlled temperature, and optionally have a decompression device for accelerating the drying operation or a cooling device.

The heating device is not specifically restricted, and includes, for example, Loedige Mixer (manufactured by Matsubo Corporation) and Solidaire (manufactured by Hosokawa Micron Corporation).

The heating temperature is set at the optimum expansion temperature for the heat-expandable microspheres to be heated, and the temperature preferably ranges from 100 to 300° C., more preferably from 130 to 270° C. and further more preferably from 150 to 250° C.

### Compositions and Formed Products

The composition of the present invention comprises a base component and at least one (hereinafter also simply referred to as the material) selected from the group consisting of the heat-expandable microspheres, the hollow particles and the fine-particle-coated hollow particles mentioned above.

The base component includes, for example, rubbers, such as natural rubbers, butyl rubber, silicone rubber and ethylene-propylene-diene rubber (EPDM); thermosetting resins, such as unsaturated polyester resins, epoxy resins and phenolic resins; waxes, such as polyethylene waxes and paraffin waxes; thermoplastic resins, such as ethylene-vinyl acetate copolymer (EVA), ionomers, polyethylene, polypropylene, polyvinyl chloride (PVC), acrylic resin, thermoplastic polyurethane, acrylonitrile-styrene copolymer (AS resin), acrylonitrile-butadiene-styrene copolymer (ABS resin), polystyrene (PS), polyamide resin (nylon 6, nylon 66, etc.), polycarbonate, polyethylene terephthalate (PET), polybutylene terephthalate (PBT), polyacetal (POM) and polyphenylene sulfide (PPS); thermoplastic elastomers, such as olefin elastomers and styrene elastomers; bioplastics, such as polylactic acid (PLA), cellulose acetate, PBS, PHA and starch resins; sealing materials, such as silicones, modified silicones, polysulfides, modified polysulfides, urethanes, acrylates, polyisobutylenes and butyl rubbers; paint ingredients, such as urethane polymers, ethylene-vinyl acetate copolymers, vinyl chloride polymers and acrylate polymers; and inorganic materials, such as cement, mortar and cordierite. One of or a combination of at least two of those base components can be used.

The composition of the present invention is prepared by mixing the particulate material, base component and other optional components. The composition of the present invention can also be prepared by mixing another base component with the composition prepared by mixing the particulate material and a base component.

Other optional components include, for example, reinforcement fibers, such as glass fiber, carbon fiber and natural fibers; inorganic powders, such as talc, titanium oxide, silica, calcium carbonate, and inorganic pigments; polymer particulates, such as acrylate particulates, styrene particulates, urethane particulates, and silicone particulates; pigments; flame retardants; chemical blowing agents; and oils, such as silicone oil and paraffin oil.

The amount of the particulate material in the composition of the present invention preferably ranges from 0.1 to 20 parts by weight to 100 parts by weight of the base component. An amount within the above range attains the composition which is lightweight and retains the desirable properties of the base component. The upper limit of the content preferably is 15 parts by weight, more preferably 13 parts by weight, and further more preferably 10 parts by weight. On the other hands the lower limit of the content preferably is 0.3 parts by weight, more preferably 0.5 parts by weight, and further more preferably 1 part by weight.

The process for preparing the composition of the present invention is not specifically restricted and is the process with any of kneader, roller kneader, mixing roller, mixer, single screw extruder, twin screw extruder, and multi-screw extruder.

The hollow particles manufactured by expanding the heat-expandable microspheres of the present invention resist the deformation of their shell against a high external pressure as mentioned above. Thus, it is expected that the hollow particles can be used in those application fields where conventional hollow particles could not satisfy the requirement for a lightweight filler. Such application fields include, for example, paint compositions and adhesive compositions.

The composition of the present invention can be a master batch for molding. The base component for a master batch containing heat-expandable microspheres is a material which softens or melts at a temperature lower than the expansion-starting temperature of the heat-expandable microspheres.

The base component which softens or melts at a temperature lower than the expansion-starting temperature of heat-expandable microspheres include, for example, waxes, such as polyethylene waxes and paraffin waxes; thermoplastic resins, such as ethylene-vinyl acetate copolymer (EVA), polyethylene, modified polyethylene, polypropylene, modified polypropylene, modified polyolefin, polyvinyl chloride (PVC), acrylate resin, thermoplastic polyurethane, acrylonitrile-styrene copolymer (AS resin), acrylonitrile-butadiene-styrene copolymer (ABS resin), polystyrene (PS), polycarbonate, polyethylene terephthalate (PET) and polybutylene terephthalate (PBT); ionomer resins, such as ethylene ionomers, urethane ionomers, styrene ionomers and fluorine ionomers; and thermoplastic elastomers, such as olefin elastomers, styrene elastomers and urethane elastomers.

The master batch for molding is preferably employed in injection molding, extrusion molding and press molding to manufacture molded resin products for the purpose of introducing vacancy into the molded products.

The resins used to manufacture molded resin products with the master batch can be selected from the base components mentioned above. The resins include, for example, ethylene-vinyl acetate copolymer (EVA), polyethylene, modified polyethylene, polypropylene, modified polypropylene, modified polyolefin, polyvinyl chloride (PVC), acrylate resin, thermoplastic polyurethane, acrylonitrile-styrene copolymer (AS resin), acrylonitrile-butadiene-styrene copolymer (ABS resin), polystyrene (PS), nylon 6, nylon 66, modified polyamide, polycarbonate, polyethylene terephthalate (PET), polybutylene terephthalate (PBT), polyacetal (POM), polyphenylene sulfide (PPS), polyphenylene ether (PPE), modified polyphenylene ether, ionomer resin, olefin elastomers, styrene elastomers, polyester elastomers, polylactic acid (PLA), cellulose acetate, PBS, PHA, starch resins, natural rubbers, isoprene rubber (IR), butadiene rubber (BR), styrene-butadiene rubber (SBR), chloroprene rubber (CR), nitryl rubber (NBR), butyl rubber, silicone rubber, acrylic rubber, urethane rubber, fluorine rubber, ethylene-propylene-diene rubber (EPDM), and their mixture.

The amount of the particulate material in the composition of the present invention, which is used as the masterbatch, is not specifically restricted and preferably is higher than 20 parts by weight and not higher than 750 parts by weight to 100 parts by weight of the base component. The amount within the above range attains sufficient dispersion of the particulate material in the base component and thus attains sufficiently lightweight molded products. The upper limit of the amount preferably is 500 parts by weight, more preferably 300 parts by weight and further more preferably 200 parts by weight. On the other hand, the lower limit of the amount preferably is 40 parts by weight and more preferably 50 parts by weight.

The formed product of the present invention is manufactured by forming the composition mentioned above.

The formed product of the present invention includes, for example, coatings and molded products.

The formed product of the present invention has improved properties, such as lightweight property, porosity, sound absorbency, thermal insulation property, low thermal conductivity, permittivity-decreasing property, design potential, shock absorbing performance, strength, and chipping resistance. Furthermore, the formed product of the present invention is expected to retain a stable shape against sink marks or distortion, minimize its shrinkage and attain high dimensional stability.

The formed product containing an inorganic materials as the base component can be further burned for processing into a ceramic filter and the like.

### EXAMPLES

Specific Examples of the heat-expandable microspheres of the present invention are described below.

However, the present invention should not be construed as being restricted within the scope of these Examples. In the following Examples and Comparative Examples, “%” means “wt %” and “part(s)” means “part(s) by weight” unless otherwise specified. Furthermore, heat-expandable microspheres may be referred to as “microspheres” for the sake of brevity.

The properties and performances of the heat-expandable microspheres, hollow particles and fine-particle-coated particles mentioned in the following Examples and Comparative Examples were tested or evaluated in the procedure mentioned below.

### Determination of Mean Volume Particle Size (D50) and Particle Size Distribution of Heat-Expandable Microspheres

A sample of heat-expandable microspheres was analyzed with a Microtrac particle size analyzer manufactured by Nikkiso Co., Ltd. (9320-HRA) to determine the mean volume diameter D50, which was defined as the average particle size of the microspheres.

### Determination of Mean Volume Particle Size of Hollow Particles

A sample of hollow particles was analyzed in dry system with a laser diffraction particle size analyzer manufactured by Malvern (MASTRSIZER 3000). The mean volume diameter D₅₀ determined in the analysis was defined as the mean particle size.

Determination of the Expansion-Starting Temperature (Tₛ) and the Maximum Expansion Temperature (Tₘₐₓ) of Heat-Expandable Microspheres

The expansion-starting temperature and maximum expansion temperature of microspheres were determined with a DMA (DMA Q800, manufactured by TA Instruments). In an aluminum cup (4.8 mm deep and 6.0 mm in diameter), 0.5 mg of a sample of microspheres was placed, and the microspheres were covered with an aluminum cap (5.6 mm in diameter and 0.1 mm thick) to prepare a test sample. The test sample was set on the device and subjected to a pressure of 0.01 N with the compression unit of the device, and the height of the sample was measured. The sample was then heated by elevating the temperature at a rate of 10° C./min from 20 to 350° C., while being subjected to a pressure of 0.01 N with the compression unit, and the change in the height of the sample was measured. The temperature at which the height started to increase was determined as the expansion-starting temperature (Tₛ) and the temperature at which the compression unit indicated the highest position was determined as the maximum expansion temperature (Tₘₐₓ).

### True Specific Gravity (d₁) of Heat-Expandable Microspheres

The true specific gravity (d₁) of the heat-expandable microspheres was determined in the following procedure.

Specifically, the true specific gravity of the heat-expandable microspheres was determined by the liquid substitution method (Archimedean method) with isopropyl alcohol in an atmosphere at 25° C. and 50% RH (relative humidity) as described below.

At first, an empty 100-mL measuring flask was dried and weighed (W_{B1} [g]). Then, isopropyl alcohol was poured into the weighed measuring flask accurately to form a meniscus, and the measuring flask filled with isopropyl alcohol was weighed (W_{B2} [g]). The 100-mL measuring flask was then emptied, dried, and weighed (W_{S1} [g]). About 50 mL of the heat-expandable microspheres were placed in the weighed measuring flask, and the measuring flask containing the heat-expandable microspheres was weighed (W_{S2} [g]). Then isopropyl alcohol was poured into the measuring flask containing the heat-expandable microspheres to form a meniscus accurately without taking bubbles into the isopropyl alcohol, and the flask containing the heat-expandable microspheres and isopropyl alcohol was weighed (W_{S3} [g]). The values, W_{B1}, W_{B2}, W_{S1}, W_{S2}, and W_{S3}, were introduced into the following formula to calculate the true specific gravity (d₁) of the heat-expandable microspheres.

$${d}_{1} = [ ( {W}_{S 2} - {W}_{S 1} ) \times ( {W}_{B 2} - {W}_{B 1} ) / 100 ] / [ ( {W}_{B 2} - {W}_{B 1} ) - ( {W}_{S 3} - {W}_{S 2} ) ]$$

### True Specific Gravity (d) of Hollow Particles

The true specific gravity of hollow particles (d₂) was determined in the same manner as that for the true specific gravity (d₁) of the heat-expandable microspheres described above.

### True Specific Gravity (d₃) of Fine-Particle-Coated Hollow Particles

The true specific gravity of fine-particle-coated hollow particles (d₃) was determined in the same manner as that for the true specific gravity (d₁) of the heat-expandable microspheres described above.

### True Specific Gravity (d₄) of Hollow Particles Contained in Fine-Particle-Coated Hollow Particles

The true specific gravity (d₄) of the hollow particles contained in fine-particle-coated hollow particles (d₄) was determined in the following procedure.

At first, the fine particles coating the fine-particle-coated hollow particles were flushed out in pretreatment. Specifically, the fine-particle-coated hollow particles were mixed with water and, if necessary, with an acid or base, and the mixture was stirred to decompose or flush out the fine particles. Then, the mixture was filtered to be separated into solid and liquid portions. The treatments were repeated several times until hollow particles without the fine particles were obtained. In the case that the hollow particles are coated with fine particles of calcium carbonate or magnesium hydroxide, the fine particles can be removed by washing with hydrochloric acid followed with rinsing in water several times to obtain hollow particles without the fine particles.

Then, the resultant hollow particles were dried. The true specific gravity (d₄) of the resultant hollow particles was determined in the same manner as in the determination of the true specific gravity (d₁) of the heat-expandable microspheres described above.

### Moisture Content of Heat-Expandable Microspheres and (Fine-Particle-Coated) Hollow Particles

The moisture content of a sample of heat-expandable microspheres and (fine-particle-coated) hollow particles was determined with a Karl Fischer moisture meter (MKA-510N, manufactured by Kyoto Electronics Manufacturing Co., Ltd.). The moisture content (wt %) of the heat-expandable microspheres and (fine-particle-coated) hollow particles are respectively represented by C_{w1} and C_{w2}.

Cw₁: moisture content (wt %) of heat-expandable microspheres

Cw₂: moisture content (wt %) of (fine-particle-coated) particles

### Encapsulation Ratio of a Blowing Agent (C₁) in Heat-Expandable Microspheres

1.0 g of a sample of heat-expandable microspheres was placed in a stainless-steel evaporating dish 15 mm deep and 80 mm in diameter, and weighed (W₁, [g]). Then, 30 mL of acetonitrile was added to disperse the microspheres uniformly. After being left for 24 hours at room temperature, the sample was dried under reduced pressure at 130° C. for 2 hours, and the dry weight (W₂, [g]) was determined.

The encapsulation ratio of the blowing agent (C₁, [wt %]) in the heat-expandable microspheres was calculated by the following formula. The moisture content of the heat-expandable microspheres, C_{w1}, was measured by the method mentioned above.

$${C}_{1} = 100 \times \{ 100 \times ( {W}_{1} - {W}_{2} ) / 1. - {C}_{w 1} \} / ( 100 - {C}_{w 1} )$$

### Encapsulation Ratio of a Thermally Gasifiable Chemical Compound (Blowing Agent) (C₂) in Hollow Particles

0.5 g of a sample of hollow particles was placed in a stainless-steel evaporating dish 15 mm deep and 80 mm in diameter, and weighed (W₃, [g]). Then, 30 mL of acetonitrile was added to disperse the particles uniformly. After being left for 24 hours at room temperature, the sample was dried under reduced pressure at 130° C. for 2 hours, and the dry weight (W₄, [g]) was determined.

The encapsulation ratio of the thermally gasifiable chemical compound (blowing agent) (C₂, [wt %]) in the hollow particles was calculated by the following formula. The moisture content of the hollow particles, Cw₂, was measured by the method mentioned above.

C₂=100×{100×(W₃−W₄)/1.0−C_{w2}}/(100−C_{w2})

### Encapsulation Ratio of a Thermally Gasifiable Chemical Compound (Blowing Agent) (C₃) in the Hollow Particles Contained in Fine-Particle-Coated Hollow Particles

The encapsulation ratio of a thermally gasifiable chemical compound (blowing agent) (C₃) in the hollow particles contained in fine-particle-coated hollow particles was determined as described below.

At first, the fine particles coating the hollow particles was washed out as the pretreatment. Specifically, fine-particle-coated hollow particles were mixed with water and, if necessary, with an acid or base, the mixture was stirred to decompose or flush out the fine particles. Then the mixture was filtered to be separated into solid and liquid portions. The treatments were repeated several times until hollow particles without the fine particles.

Then the resultant hollow particles were dried. The encapsulation ratio of the thermally gasifiable chemical compound (blowing agent) (C₃, wt %) in the hollow particles was determined in the same manner as in the determination of the encapsulation ratio of a blowing agent (C₂) in the hollow particles described above.

### Content of Organic Silicon (C₄) in Heat-Expandable Microspheres

10.0 g of a sample of heat-expandable microspheres was placed in a stainless-steel evaporating dish 15 mm deep and 80 mm in diameter. Then, 50 mL of methanol was added to disperse the microsphere uniformly and immerse the microspheres evenly, and the dish was lidded and stood still at an ambient temperature of 25° C. for 2 hours. Then, all the heat-expandable microspheres (S) after the immersion were collected. The collected heat-expandable microspheres (S) were stood still at an ambient temperature of 40° C. for 24 hours to completely evaporate the methanol, and the weight (W₅, [g]) of the heat-expandable microspheres (S) was measured. The encapsulation ratio of the blowing agent (C₅) in the heat-expandable microspheres (S) was determined in the same manner as in the determination of the encapsulation ratio of a blowing agent (C₁) in heat-expandable microspheres described above.

Then, the obtained W₅ and C₅ and C₁ were introduced in the following formula to calculate the content of the organic silicon compound (C₄, [parts by weight]).

$${C}_{4} = \{ ( 10.0 ‐ {W}_{5} ) / 10. \} \times 100 - ( {C}_{1} - {C}_{5} )$$

### Identification of Organic Silicon Compound Contained in Heat-Expandable Microspheres

A proper amount of heat-expandable microspheres and an epoxy adhesive were mixed to disperse the microspheres uniformly and the mixture was cured. The cured product was cut with a razor to cut the heat-expandable microspheres. The cut heat-expandable microspheres were observed thorough a tabletop scanning electron microscope (Miniscope™, TM3030 Plus, manufactured by Hitachi High-Tech Corporation), and elemental analysis was performed on the cross section of the heat-expandable microspheres by energy dispersive X-ray spectroscopy (EDX). The existence and location of the organic silicon compound were confirmed by the distribution of silicon obtained from the analysis of the cross section of the heat-expandable microspheres.

### Maximum Expansion Ratio (Rₑₓ) Of Heat-Expandable Microspheres

The maximum expansion ratio of heat-expandable microspheres is defined as the ratio of the volume of heat-expandable microspheres at their maximum expansion to the volume of the heat-expandable microspheres before thermal expansion.

In an aluminum container (C-1, manufactured by AS ONE Corporation), 1 g of a sample of heat-expandable microspheres was placed and sealed with aluminum foil to prevent the leakage of the sample. The container was placed in an oven (PHH-102, manufactured by Espec Corp.), the temperature of which was checked to be have stabilized.

The true specific gravity of the heat-expandable microspheres after the heating (expanding) was determined in the same manner as in the determination of the true specific gravity (d₂) of hollow particles described above.

The heat-expandable microspheres were heated in the oven at several temperature levels, which are within the range from their expansion-starting temperature determined in the procedure mentioned above to a temperature 100° C. higher than their maximum expansion temperature, respectively, for 2 minutes at each temperature level. The lowest value of the true specific gravity of the resultant expanded microspheres was taken as the maximum expansion of the microspheres for determining their maximum expansion ratio. The maximum expansion ratio (Rₑₓ) of the heat-expandable microspheres was calculated by the following formula.

d₁: the true specific gravity of heat-expandable microspheres before expansion

d₅: the true specific gravity of heat-expandable microspheres at their maximum expansion

$$Rex = ( {d}_{1} / {d}_{5} )$$

### Pressure Resistance

A vinyl chloride paste was prepared by mixing 56 parts by weight of vinyl chloride resin, 92 parts by weight of diisononyl phthalate as a plasticizer and 52 parts by weight of calcium carboxylate as a filler. The resultant vinyl chloride paste had a specific gravity of 1.3. A predetermined amount of hollow particles or fine-particle-coated hollow particles was blended with the vinyl chloride paste, and the bubbles in the blend were eliminated to prepare a vinyl chloride compound having a specific gravity of 1.0. The specific gravity, 1.0, of the vinyl chloride compound was confirmed by the determination according to JIS K-5600 with a specific gravity cup.

About 180 mL of each of the vinyl chloride compounds prepared as described above was poured in a pressure-tight container and pressurized with a press under the respective conditions; (i) at 20 MPa for 20 min, (ii) at 20 MPa for 1 hour, (iii) at 20 MPa for 5 hours, and (iv) at 20 MPa for 24 hours. After pressurizing, the foam in the compound was eliminated with a stirring defoamer, and the specific gravity of the compound was determined by using a 50-mL specific gravity cup to evaluate the durability of the hollow particles and fine-particle-coated hollow particles against deformation by external pressure.

Deformation Ratio of the Hollow Particles (R) after Pressure Resistance Test

A vinyl chloride compound with a specific gravity of 1.0 was prepared by blending a prescribed amount of hollow particles or fine-particle-coated hollow particles with the vinyl chloride paste, (with a specific gravity of 1.3) which was the same as used in the pressure resistance test described above.

About 180 mL of the vinyl chloride compound prepared as described above was poured in a pressure-tight container and pressurized with a press (iv) at 20 MPa for 24 hours to evaluate the pressure resistance of the particles. After the pressure resistance test, the foam in the compound was eliminated with a stirring defoamer and the specific gravity of the compound (d_{c}) was determined by using a 50-mL specific gravity cup.

The true specific gravity (d_{d}) of the hollow particles or fine-particle-coated hollow particles after the pressure resistance test was calculated by the following formula from the specific gravity (d_{c}) of the vinyl chloride compound determined in the pressure resistance test, the true specific gravity (dₐ) and the weight (Wₐ) of the blended vinyl chloride and the weight (W_{b}) of the blended hollow particles or fine-particle-coated hollow particles.

The deformation ratio of the hollow particles (R) was calculated from the true specific gravity (d_{d}) of the hollow particles or fine-particle-coated hollow particles after the pressure resistance test and the true specific gravity (d_{b}) of the hollow particles or fine-particle-coated hollow particles before the pressure resistance test by the following formula.

$$\begin{matrix}{d}_{d} = {W}_{b} / [ \{ ( {W}_{a} + {W}_{b} ) - {d}_{c} \times ( {W}_{a} / {d}_{a} ) \} / {d}_{c} ] \\ R = ( {d}_{b} / {d}_{d} ) \times 100\end{matrix}$$

The deformation ratio, R, after the pressure resistance test (iv) at 20 MPa for 24 hours was evaluated by the following criteria.

Poor: 40>R

Acceptable: 70>R≥40

Good: R≥70

### Example 1 (Microspheres 1)

An aqueous dispersion medium was prepared by dissolving 110 parts of sodium chloride in 450 parts of deionized water, adding 0.9 parts of polyvinyl pyrrolidone, 65 parts of colloidal silica containing 20 wt % of silica and 0.04 parts of carboxymethylated polyethylene imine sodium salt and adjusting the pH of the mixture to 3.0.

An oily mixture was prepared by mixing 150 parts of acrylonitrile, 48 parts of methacrylonitrile, 9 parts of methyl methacrylate, 2 parts of diethylene glycol dimethacrylate (EDMA), 3 parts of di(2-ethylhexyl) peroxydicarbonate (P-OPP), 28 parts of isobutane, and 5 parts of organopolysiloxane (R-220L, manufactured by Shin-Etsu Chemical Co., Ltd.).

The aqueous dispersion medium and oily mixture were mixed and agitated with a Homo-mixer (TK Homomixer, manufactured by Primix Corporation) at 10,000 rpm for 1 min to prepare suspension. Then, the suspension was transferred to a compressive reactor of 1.5-liter capacity, purged with nitrogen and polymerized at 60° C. for 20 hours with agitation at 80 rpm under the initial reaction pressure of 0.35 MPa. The resultant polymerization product was filtered and dried to prepare heat-expandable microspheres 1. The properties of the resultant heat-expandable microspheres are shown in Table 1.

### Examples 2 to 15 (Microspheres 2 to 15) and Comparative Examples 1 to 5 (Microspheres A to E)

The heat-expandable microspheres of the Examples 2 to 15 and Comparative Examples 1 to 5 were produced in the same manner as in Example 1; except that the reaction parameters were changed as shown in Tables 1 and 2.

The details of the ingredients used are shown in Table 3 and the names of some of the ingredients shown in Tables 1 and 2 are abbreviated as follows.

EDMA: diethylene glycol dimethacrylate

TMP: trimethylol propane trimethacrylate

BAC-45: polybutadiene diacrylate, M.W. approx. 10000, manufactured by Osaka Organic Chemical Industry Ltd.

Isobutane: 2-methyl propane

Isopentane: 2-methyl butane

Isooctane: 2,2,4-trimethyl pentane

TABLE 1

| | | | Examples | | | | | | | | | |
|---|---|---|---|---|---|---|---|---|---|---|---|---|
| | | | 1 | 2 | 3 | 4 | 5 | 6 | 7 | 8 | 9 | 10 |
| | | | Micro- | Micro- | Micro- | Micro- | Micro- | Micro- | Micro- | Micro- | Micro- | Micro- |
| | | | spheres | spheres | spheres | spheres | spheres | spheres | spheres | spheres | spheres | spheres |
| | | | 1 | 2 | 3 | 4 | 5 | 6 | 7 | 8 | 9 | 10 |
| Oily | Uncross- | Acrylonitrile | 150 | 150 | 150 | 150 | 184 | 185 | 165 | 176 | 178 | 156 |
| mixture | linkable | Methacrylonitrile | 48 | 48 | 48 | 48 | 30 | 8 | 15 | 8 | 2 | — |
| (parts by | monomer | Methyl | 9 | 9 | — | — | — | — | — | — | — | — |
| weight) | | methacrylate | | | | | | | | | | |
| | | Methacrylic | — | — | 9 | 9 | 24 | 47 | 60 | 60 | 60 | 84 |
| | | acid | | | | | | | | | | |
| | Cross- | EDMA | 2 | 2 | 1.2 | — | — | 0.6 | — | — | 2.5 | — |
| | linkable | TMP | — | — | — | — | 0.5 | — | — | — | — | — |
| | monomer | BAC-45 | — | — | — | 2 | 1.4 | 2 | 2.4 | 2.2 | — | 2.2 |
| | Polymerization | P-OPP | 3 | 3 | 3 | 3 | 3 | 3 | 3 | 3 | 3 | 3 |
| | initiator | | | | | | | | | | | |
| | Blowing | Isobutane | 28 | 28 | 26 | 28 | 23 | 28 | 11 | 46 | 35 | 33 |
| | agent | Isopentane | 10 | 10 | — | — | 10 | — | 19 | 5 | — | — |
| | | Isooctane | — | — | — | — | — | 2 | — | — | — | 2 |
| | Organic | KR-220L | 5 | — | — | — | — | — | — | 2 | — | — |
| | silicon | KR-220LP | — | 2.5 | 10 | 22 | 40 | — | 10 | — | 60 | 5 |
| | compound | KR-300 | — | — | — | — | — | — | — | — | — | 7 |
| | | KR-500 | — | 2.5 | — | — | — | 6.0 | — | — | — | — |
| | | KC-89S | — | — | — | — | — | — | — | 2 | — | — |
| | | KR-255 | — | — | — | — | — | — | — | — | — | — |

| | | | | | | | | | | | |
|---|---|---|---|---|---|---|---|---|---|---|---|
| | 828US | — | — | — | — | — | — | — | — | — | — |
| | 3-methacryloxy propyl | — | — | — | — | — | — | — | — | — | — |
| | trimethoxy silane | | | | | | | | | | |
| Aqueous | Deionized water | 450 | 450 | 450 | 450 | 550 | 550 | 550 | 550 | 550 | 550 |
| dispersion | Sodium chloride | 110 | 110 | 110 | 110 | 147 | 147 | 147 | 147 | 147 | 147 |
| medium | Polyvinyl pyrrolidone | 0.9 | 0.9 | 0.9 | 0.9 | 0.9 | 0.9 | 0.9 | 0.9 | 0.9 | 0.9 |
| (parts by | Colloidal silica | 65 | 65 | 65 | 58 | 70 | 65 | 65 | 58 | 60 | 65 |
| weight) | Carboxymethylated | 0.04 | 0.04 | 0.04 | 0.04 | 0.04 | 0.04 | 0.04 | 0.04 | 0.04 | 0.04 |
| | polyethylene imine | | | | | | | | | | |
| | sodium salt | | | | | | | | | | |
| | pH | 3.0 | 3.0 | 3.0 | 3.0 | 3.0 | 3.0 | 3.0 | 3.0 | 3.0 | 3.0 |
| Properties | Mean volume particle | 21 | 21 | 21 | 32 | 18 | 22 | 21 | 30 | 25 | 21 |
| of heat- | size (μm) | | | | | | | | | | |
| expandable | True specific gravity (d1) | 1.10 | 1.10 | 1.14 | 1.16 | 1.18 | 1.13 | 1.15 | 1.10 | 1.19 | 1.12 |
| microspheres | Encapsulation ratio of a | 14.6 | 14.6 | 10.0 | 10.2 | 9.6 | 10.0 | 9.6 | 15.8 | 9.5 | 11.2 |
| | blowing agent (C1) (wt %) | | | | | | | | | | |
| | Ts (° C.) | 115 | 115 | 115 | 115 | 140 | 160 | 170 | 170 | 170 | 190 |
| | Tmax (° C.) | 161 | 162 | 168 | 170 | 180 | 205 | 220 | 220 | 220 | 250 |
| | Maximum expansion | 73 | 73 | 76 | 77 | 56 | 70 | 58 | 92 | 54 | 62 |
| | ratio (Rex) | | | | | | | | | | |
| | Content of organic silicon | 2.0 | 1.9 | 4.1 | 8.4 | 12.8 | 2.1 | 3.5 | 1.32 | 17.7 | 4.1 |
| | (C4) (parts by weight) | | | | | | | | | | |

TABLE 2

| | | | Examples | | | | | Comparative Examples | | | | |
|---|---|---|---|---|---|---|---|---|---|---|---|---|
| | | | 11 | 12 | 13 | 14 | 15 | 1 | 2 | 3 | 4 | 5 |
| | | | Micro- | Micro- | Micro- | Micro- | Micro- | Micro- | Micro- | Micro- | Micro- | Micro- |
| | | | spheres | spheres | spheres | spheres | spheres | spheres | spheres | spheres | spheres | spheres |
| | | | 11 | 12 | 13 | 14 | 15 | A | B | C | D | E |
| Oily | Uncross- | Acrylonitrile | 120 | 96 | 180 | 168 | 176 | 150 | 150 | 165 | 96 | 150 |
| mixture | linkable | Methacrylonitrile | 31 | 96 | 42 | 48 | 8 | 48 | 48 | 15 | 96 | 48 |
| (parts by | monomer | Methyl | — | — | — | — | — | 9 | — | — | — | — |
| weight) | | methacrylate | | | | | | | | | | |
| | | Methacrylic | 91 | 49 | 18 | 24 | 60 | — | 9 | 60 | 49 | 9 |
| | | acid | | | | | | | | | | |
| | Cross- | EDMA | — | — | — | — | — | 2 | 1.2 | — | — | 1.2 |
| | linkable | TMP | — | 1.8 | — | — | — | — | — | — | 1.8 | — |
| | monomer | BAC-45 | 1 | — | 2.2 | 3 | 2.2 | — | — | 2.4 | — | — |
| | Polymerization | P-OPP | 3 | 3 | 3 | 3 | 3 | 3 | 3 | 3 | 3 | 3 |
| | initiator | | | | | | | | | | | |
| | Blowing | Isobutane | 20 | — | 40 | 30 | 30 | 28 | 26 | 11 | — | 26 |
| | agent | Isopentane | 26 | 24 | — | 10 | 5 | 10 | — | 19 | 24 | — |
| | | Isooctane | 6 | 48 | — | — | — | — | — | — | 48 | — |
| | Organic | KR-220L | 10 | — | — | — | — | — | — | — | — | — |
| | silicon | KR-220LP | — | 4.8 | 16 | 8 | 5 | — | — | — | — | — |
| | compound | KR-300 | — | — | — | — | — | — | — | — | — | — |
| | | KR-500 | — | — | — | — | — | — | — | — | — | — |
| | | KC-89S | — | — | — | — | — | — | — | — | — | — |
| | | KR-255 | | | — | — | 10 | | | | | |

| | | | | | | | | | | | |
|---|---|---|---|---|---|---|---|---|---|---|---|
| | 828US | — | — | — | — | — | — | — | — | 4.8 | — |
| | 3-methacryloxy propyl | — | — | — | — | — | — | — | — | — | 10 |
| | trimethoxy silane | | | | | | | | | | |
| Aqueous | Deionized water | 550 | 600 | 550 | 550 | 600 | 450 | 450 | 550 | 600 | 450 |
| dispersion | Sodium chloride | 147 | 147 | 147 | 147 | 147 | 110 | 110 | 147 | 147 | 110 |
| medium | Polyvinyl pyrrolidone | 0.9 | 2 | 1 | 1 | 1 | 0.9 | 0.9 | 0.9 | 2 | 0.9 |
| (parts | Colloidal silica | 55 | 60 | 70 | 60 | 60 | 65 | 65 | 65 | 60 | 65 |
| by weight) | Carboxymethylated | 0.04 | 0.04 | 0.04 | 0.04 | 0.04 | 0.04 | 0.04 | 0.04 | 0.04 | 0.04 |
| | polyethylene imine | | | | | | | | | | |
| | sodium salt | | | | | | | | | | |
| | pH | 3.0 | 3.0 | 3.0 | 3.0 | 3.0 | 3.0 | 3.0 | 3.0 | 3.0 | 3.0 |
| Properties | Mean volume particle | 30 | 25 | 21 | 30 | 27 | 21 | 21 | 22 | 25 | 21 |
| of heat- | size (μm) | | | | | | | | | | |
| expandable | True specific | 1.03 | 1.05 | 1.14 | 1.12 | 1.08 | 1.07 | 1.08 | 1.12 | 1.04 | 1.10 |
| microspheres | gravity (d1) | | | | | | | | | | |
| | Encapsulation ratio | 16.3 | 19.5 | 11.8 | 12.0 | 10.3 | 14.7 | 9.6 | 9.5 | 19.5 | 9.8 |
| | of a blowing | | | | | | | | | | |
| | agent (C1) (wt %) | | | | | | | | | | |
| | Ts (° C.) | 170 | 160 | 122 | 131 | 172 | 115 | 115 | 170 | 160 | 115 |
| | Tmax (° C.) | 240 | 210 | 174 | 180 | 215 | 160 | 162 | 205 | 200 | 162 |
| | Maximum expansion | 103 | 76 | 59 | 64 | 51 | 71 | 54 | 51 | 69 | 55 |
| | ratio (Rex) | | | | | | | | | | |
| | Content of organic silicon | 3.3 | 1.5 | 5.3 | 2.7 | 5 | 0 | 0 | 0 | 0 | 0 |
| | (C4) (parts by weight) | | | | | | | | | | |

TABLE 3

| Ingredient | Detail |
|---|---|
| KR-220L | Organopolysiloxane manufactured by Shin-Etsu Chemical Co., Ltd., Having 98% of T unit (R¹SiO_{3/2}) |
| | where R¹ is methyl group, Having silanol group, Weight average molecular weight: 4720, Softening |
| | temp.: 70° C., Curing temp.(T Gel): 140° C. |
| KR-220LP | Organopolysiloxane manufactured by Shin-Etsu Chemical Co., Ltd., Having 98% of T unit (R¹SiO_{3/2}) |
| | where R¹ is methyl group, Having silanol group, Weight average molecular weight: 4720, Softening |
| | temp.: 70° C., Curing temp.(T Gel): 140° C. |
| KR-300 | Organopolysiloxane manufactured by Shin-Etsu Chemical Co., Ltd., Having T unit (R¹SiO_{3/2}) where R¹ |
| | includes methyl group and phenyl group, Having silanol group |
| KR-500 | Alkoxy siloxane manufactured by Shin-Etsu Chemical Co., Ltd., Having T unit (R¹SiO_{3/2}) where R¹ is |
| | methyl group, Having alkoxysilyl group, Weight average molecular weight: 1240 |
| KC-89S | Alkoxy siloxane manufactured by Shin-Etsu Chemical Co., Ltd.: having T unit (R¹SiO_{3/2}) where R¹ is |
| | methyl group, Having alkoxysilyl group, Molecular weight: 280 |
| KR-255 | Organopolysiloxane manufactured by Shin-Etsu Chemical Co., Ltd., Having T unit (R¹SiO_{3/2}) and D |
| | unit (R²₂SiO_{2/2}) where R¹ and R² include methyl group and phenyl group, Having silanol group, Weight |
| | average molecular weight: 300000 |
| 828US | Bisphenol A epoxy resin manufactured by Mitsubishi Chemical Corporation, Molecular weight: 370 |

### Example of Production 1 (Fine-Particle-Coated Hollow Particles 1)

In Example of production 1, 25 parts of the microspheres 1 produced in Example 1 and 75 parts of calcium carbonate (Whiten SB Red, with mean particle size about 1.8 μm determined by laser diffractometry, manufactured by Bihoku Funka Kogyo Co., Ltd.) were mixed in a separable flask. The mixture was heated to 150° C. with agitation over 5 minutes and the temperature, 150° C., was retained for 3 minutes to produce the fine-particle-coated hollow particles 1. The true specific gravity of the fine-particle-coated hollow particles was 0.16, and the true specific gravity of the hollow particles contained in the fine-particle-coated hollow particles was 0.042. The encapsulation ratio of the blowing agent (C₃) was 14.5 wt %.

### Examples of Production 2 to 12 and 16 to 18 (Fine-Particle-Coated Hollow Particles 2 to 15 and 16 to 18) and Comparative Examples of Production 1 to 5 (Fine-Particle-Coated Hollow Particles A to E)

In Examples of production 2 to 12, Examples of production 16 to 18 and Comparative Examples of production 1 to 5, the fine-particle-coated hollow particles were manufactured in the same manner as in Example of production 1 according to the formulations shown in Tables 4 to 6. The production was performed in accordance with the heating temperature and conditions shown below. The properties of the resultant fine-particle-coated hollow particles are shown in Tables 4 to 6.

Example of production 2: heating to 150° C. over 5 minutes and retaining the temperature, 150° C., for 3 minutes

Example of production 3: heating to 155° C. over 5 minutes and retaining the temperature, 155° C., for 3 minutes

Example of production 4: heating to 155° C. over 5 minutes and retaining the temperature, 155° C., for 3 minutes

Example of production 5: heating to 170° C. over 7 minutes without further retention of the temperature

Example of production 6: heating to 185° C. over 7 minutes without further retention of the temperature

Example of production 7: heating to 195° C. over 7 minutes without further retention of the temperature

Example of production 8: heating to 190° C. over 7 minutes without further retention of the temperature

Example of production 9: heating to 200° C. over 7 minutes without further retention of the temperature

Example of production 10: heating to 220° C. over 7 minutes without further retention of the temperature

Example of production 11: heating to 220° C. over 7 minutes without further retention of the temperature

Example of production 12: heating to 195° C. over 7 minutes without further retention of the temperature

Example of production 16: heating to 170° C. over 7 minutes without further retention of the temperature

Example of production 17: heating to 175° C. over 7 minutes without further retention of the temperature

Example of production 18: heating to 200° C. over 10 minutes without further retention of the temperature

Comparative Example of production 1: heating to 150° C. over 5 minutes and retaining the temperature, 150° C., for 3 minutes

Comparative Example of production 2: heating to 155° C. over 5 minutes and retaining the temperature, 155° C., for 3 minutes

Comparative Example of production 3: heating to 195° C. over 7 minutes without further retention of the temperature

Comparative Example of production 4: heating to 185° C. over 7 minutes without further retention of the temperature

Comparative Example of production 5: heating to 155° C. over 5 minutes and retaining the temperature, 155° C., for 3 minutes

### Examples of Production 13 to 15 (Hollow Particles 13 to 15)

Hollow particles 13 to 15 were produced from the microspheres 7 obtained in Example 7 and the microspheres 10 obtained in Example 10 by dry thermal expansion. The dry thermal expansion was conducted by the internal injection method disclosed in Japanese Patent Application Publication 2006-213930, the content of which is incorporated herein by reference. Specifically, the heat-expandable microspheres were processed into hollow particles by thermal expansion with the manufacturing device having the expansion unit shown in FIG. 3 in the procedure mentioned below.

### Expansion Unit of the Manufacturing Device

As shown in FIG. 3, the expansion unit has a gas inlet tube (not indicated by a number) having the distribution nozzle (11) at its outlet and placed at the center of the part, the collision plate (12) disposed below the distribution nozzle (11), the overheat prevention jacket (10) disposed around the gas inlet tube with a clearance from the tube, and the hot air nozzle (8) disposed around the overheat prevention jacket (10) with a clearance from the jacket. A gas fluid (13) containing heat-expandable microspheres is run through the gas inlet tube in the direction of the arrow, and a gas flow (14) is run through the space between the gas inlet tube and the overheat prevention jacket (10) in the direction of the arrows in order to improve the distribution of the heat-expandable microspheres and prevent overheating of the gas inlet tube and collision plate. Furthermore, a hot airflow (15) is run through the space between the overheat prevention jacket (10) and the hot air nozzle (8) in the direction of the arrows in order to thermally expand the heat-expandable microspheres. The hot airflow (15), the gas fluid (13) and the gas flow (14) usually run in the same direction. A refrigerant flow (9) for cooling is run in the overheat protection jacket (10) in the direction of the arrows in order to cool the jacket.

### Operation of the Manufacturing Device

In the injection step, the gas fluid (13) containing heat-expandable microspheres is introduced in the gas inlet tube having the distribution nozzle (11) at its outlet and placed at the inside of the hot airflow (15), and the gas fluid (13) is injected from the distribution nozzle (11).

In the distribution step, the gas fluid (13) is made to collide with the collision plate (12) disposed below the distribution nozzle (11) and the heat-expandable microspheres are uniformly distributed in the hot airflow (15). The gas fluid (13) injected from the distribution nozzle (11) is lead to the collision plate (12) along with the gas flow (14) and collide with the collision plate.

In the expansion step, the distributed heat-expandable microspheres are heated and expanded in the hot airflow (15) at a temperature higher than their expansion-starting temperature. Then the resultant hollow particles are cooled and collected.

### Expansion Conditions and Result

In Example of production 13, the hollow particles 13 were manufactured by thermally expanding the microspheres 7 produced in Example 7 with the manufacturing device shown in FIG. 3, with the expansion parameters including a feeding rate of the microspheres 7 of 0.5 kg/mm, a flow rate of the gas fluid for distributing the microspheres 7 of 0.35 m³/min, a flow rate of the hot airflow of 8.0 m³/min and a temperature of the hot airflow at 320° C.

In Example of production 14, the hollow particles 14 were manufactured by thermally expanding the microspheres 7 produced in Example 7 with the manufacturing device shown in FIG. 3, with the expansion parameters including a feeding rate of the microspheres 7 of 0.5 kg/mm, a flow rate of the gas fluid for distributing the microspheres 7 of 0.35 m³/min, a flow rate of the hot airflow at 8.0 m³/min and a temperature of the hot airflow at 340° C.

In Example of production 15, the hollow particles 15 were manufactured by thermally expanding the microspheres 10 produced in Example 10 with the manufacturing device shown in FIG. 3, with the expansion parameters including a feeding rate of the microspheres 10 of 0.5 kg/m, a flow rate of the gas fluid for distributing the microspheres 10 of 0.35 m³/min, a flow rate of the hot airflow of 8.0 m³/min and a temperature of the hot airflow at 390° C.

The properties of the resultant hollow particles are shown in Table 5.

TABLE 4

| | | | Examples of production | | | | | | | |
|---|---|---|---|---|---|---|---|---|---|---|
| | | | 1 | 2 | 3 | 4 | 5 | 6 | 7 | 8 |
| | | | Micro- | Micro- | Micro- | Micro- | Micro- | Micro- | Micro- | Micro- |
| | Heat-expandable | | spheres | spheres | spheres | spheres | spheres | spheres | spheres | spheres |
| Material | microspheres | | 1 | 2 | 3 | 4 | 5 | 6 | 7 | 8 |
| Hollow | Resultant hollow particles | | — | — | — | — | — | — | — | — |
| particles | Ingredient | Microspheres | 25 | 35 | 30 | 30 | 25 | 35 | 40 | 40 |
| | (parts by | Calcium | 75 | 65 | 70 | 70 | 75 | 65 | 60 | 60 |
| | weight) | carbonate | | | | | | | | |
| | | (fine | | | | | | | | |
| | | particles) | | | | | | | | |

| | | | | | | | | |
|---|---|---|---|---|---|---|---|---|
| Resultant | Fine- | Fine- | Fine- | Fine- | Fine- | Fine- | Fine- | Fine- |
| fine-particle- | particle- | particle- | particle- | particle- | particle- | particle- | particle- | particle- |
| coated hollow | coated | coated | coated | coated | coated | coated | coated | coated |
| particles | hollow | hollow | hollow | hollow | hollow | hollow | hollow | hollow |

| | | particles 1 | particles 2 | particles 3 | particles 4 | particles 5 | particles 6 | particles 7 | particles 8 |
|---|---|---|---|---|---|---|---|---|---|
| (Fine particles-coated) | Mean volume | 61 | 58 | 58 | 97 | 49 | 59 | 60 | 81 |
| hollow particles | particle | | | | | | | | |
| | size (μm) | | | | | | | | |
| Hollow particles (d2) | True specific | — | — | — | — | — | — | — | — |
| Fine-particles-coated | gravity | 0.16 | 0.14 | 0.16 | 0.12 | 0.2 | 0.15 | 0.11 | 0.13 |
| hollow particles (d3) | | | | | | | | | |
| Hollow particles without | | 0.042 | 0.051 | 0.050 | 0.037 | 0.053 | 0.054 | 0.045 | 0.054 |
| fine particles (d4) | | | | | | | | | |
| Hollow particles (C2) | Encapsulation | — | — | — | — | — | — | — | — |
| Hollow particles without | ratio of | 14.5 | 14.5 | 9.8 | 10.2 | 9.6 | 10.0 | 9.6 | 15.8 |
| fine particles (C3) | blowing | | | | | | | | |
| | agent (wt %) | | | | | | | | |

TABLE 5

| | | | Examples of production | | | | | | | |
|---|---|---|---|---|---|---|---|---|---|---|
| | | | 9 | 10 | 11 | 12 | 13 | 14 | 15 | 16 |
| | | | Micro- | Micro- | Micro- | Micro- | Micro- | Micro- | Micro- | Micro- |
| | Heat-expandable | | spheres | spheres | spheres | spheres | spheres | spheres | spheres | spheres |
| Material | microspheres | | 9 | 10 | 11 | 12 | 7 | 7 | 10 | 13 |
| Hollow | Resultant hollow | | — | — | — | — | Hollow | Hollow | Hollow | — |
| particles | particles | | | | | | parti- | parti- | parti- | |
| | | | | | | | cles 13 | cles 14 | cles 15 | |
| | Ingredient | Micro- | 40 | 30 | 30 | 30 | — | — | — | 30 |
| | (parts by | spheres | | | | | | | | |
| | weight) | Calcium | 60 | 70 | 70 | 70 | — | — | — | 70 |
| | | carbonate | | | | | | | | |
| | | (fine | | | | | | | | |
| | | particles) | | | | | | | | |

| | | | | | | | | |
|---|---|---|---|---|---|---|---|---|
| Resultant | Fine- | Fine- | Fine- | Fine- | — | — | — | Fine- |
| fine-particle- | particle- | particle- | particle- | particle- | | | | particle- |
| coated hollow | coated | coated | coated | coated | | | | coated |
| particles | hollow | hollow | hollow | hollow | | | | hollow |

| | | parti- | parti- | parti- | parti- | | | | parti- |
|---|---|---|---|---|---|---|---|---|---|
| | | cles 9 | cles 10 | cles 11 | cles 12 | | | | cles 16 |
| (Fine-particle-coated) | Mean volume | 74 | 66 | 85 | 66 | 55 | 60 | 62 | 60 |
| hollow particles | particle | | | | | | | | |
| | size (μm) | | | | | | | | |
| Hollow particles (d2) | True | — | — | — | — | 0.058 | 0.044 | 0.040 | — |
| Fine-particle-coated | specific | 0.1 | 0.11 | 0.15 | 0.18 | — | — | — | 0.16 |
| hollow particles (d3) | gravity | | | | | | | | |
| Hollow particles without | | 0.041 | 0.034 | 0.047 | 0.057 | — | — | — | 0.050 |
| fine particles (d4) | | | | | | | | | |
| Hollow particles (C2) | Encapsulation | — | — | — | — | 9.6 | 9.6 | 11.2 | — |
| Hollow particles without | ratio of | 9.5 | 11.2 | 16.3 | 19.5 | — | — | — | 11.2 |
| fine particles (C3) | blowing | | | | | | | | |
| | agent (wt %) | | | | | | | | |

TABLE 6

| | | | Examples of | | Comparative Examples | | | | |
|---|---|---|---|---|---|---|---|---|---|
| | | | production | | of production | | | | |
| | | | 17 | 18 | 1 | 2 | 3 | 4 | 5 |
| | | | Micro- | Micro- | Micro- | Micro- | Micro- | Micro- | Micro- |
| | Heat-expandable | | spheres | spheres | spheres | spheres | spheres | spheres | spheres |
| Material | microspheres | | 14 | 15 | A | B | C | D | E |
| Hollow | Resultant hollow particles | | — | — | — | — | — | — | — |
| particles | Ingredient | Microspheres | 30 | 40 | 25 | 30 | 40 | 30 | 30 |
| | (parts by | Calcium | 70 | 60 | 75 | 70 | 60 | 70 | 70 |
| | weight) | carbonate | | | | | | | |
| | | (fine | | | | | | | |
| | | particles) | | | | | | | |

| | | | | | | | |
|---|---|---|---|---|---|---|---|
| Resultant | Fine- | Fine- | Fine- | Fine- | Fine- | Fine- | Fine- |
| fine-particle- | particle- | particle- | particle- | particle- | particle- | particle- | particle- |
| coated hollow | coated | coated | coated | coated | coated | coated | coated |
| particles | hollow | hollow | hollow | hollow | hollow | hollow | hollow |

| | | particles 17 | particles 18 | particles A | particles B | particles C | particles D | particles E |
|---|---|---|---|---|---|---|---|---|
| (Fine-particle-coated) | Mean volume | 85 | 70 | 61 | 58 | 63 | 66 | 59 |
| hollow particles | particle | | | | | | | |
| | size (μm) | | | | | | | |
| Hollow particles (d2) | True specific | — | — | — | — | — | — | — |
| Fine-particle-coated | gravity | 0.15 | 0.14 | 0.16 | 0.16 | 0.11 | 0.18 | 0.15 |
| hollow particles (d3) | | | | | | | | |
| Hollow particles without | | 0.047 | 0.058 | 0.042 | 0.050 | 0.045 | 0.057 | 0.047 |
| fine particles (d4) | | | | | | | | |
| Hollow particles (C2) | Encapsulation | — | — | — | — | — | — | — |
| Hollow particles without | ratio of | 11.3 | 9.8 | 14.7 | 9.5 | 9.4 | 19.2 | 9.8 |
| fine particles (C3) | blowing | | | | | | | |
| | agent (wt %) | | | | | | | |

### Test 1

A vinyl chloride paste (specific gravity: 1.30) was prepared by mixing 56 parts by weight of a vinyl chloride resin (ZEST-P-21, produced by Tokuyama Corporation), 92 parts by weight of diisononyl phthalate as a plasticizer, and 52 parts by weight of calcium carbonate as a filler. Then the paste was mixed with 8.8 parts by weight of the fine-particle-coated hollow particles 1 produced in Example of production 1, and the mixture was kneaded and defoamed with an agitation defoamer to prepare a vinyl chloride compound having a specific gravity of 1.0. The deformation resistance of the compound against external force was tested according to the procedure described in “Pressure resistance” mentioned above. The result is shown in Table 7.

### Tests 2 to 23

In Tests 2 to 23, the deformation resistance was tested in the same manner as in Test 1 except that the (fine-particle-coated) hollow particles and their amount added to the compounds shown in Tables 7 to 9 were employed. The results are shown in Tables 7 to 9.

TABLE 7

| Test No. | | | 1 | 2 | 3 | 4 | 5 | 6 | 7 | 8 |
|---|---|---|---|---|---|---|---|---|---|---|
| Vinyl | Lightweight | Hollow | Fine- | Fine- | Fine- | Fine- | Fine- | Fine- | Fine- | Fine- |
| chloride | filler | particles | particle- | particle- | particle- | particle- | particle- | particle- | particle- | particle- |
| compound | | | coated | coated | coated | coated | coated | coated | coated | coated |
| | | | hollow | hollow | hollow | hollow | hollow | hollow | hollow | hollow |
| | | | particles 1 | particles 2 | particles 3 | particles 4 | particles 5 | particles 6 | particles 7 | particles 8 |
| | | True specific | 0.16 | 0.14 | 0.16 | 0.12 | 0.20 | 0.15 | 0.11 | 0.13 |
| | | gravity | | | | | | | | |
| | | Amount | 8.8 | 7.5 | 8.8 | 6.3 | 11.5 | 8.1 | 5.7 | 6.9 |
| | | (parts by | | | | | | | | |
| | | weight) | | | | | | | | |
| | Base | Specific | 1.3 | 1.3 | 1.3 | 1.3 | 1.3 | 1.3 | 1.3 | 1.3 |
| | material | gravity | | | | | | | | |
| | | of vinyl | | | | | | | | |
| | | chloride paste | | | | | | | | |
| | | Amount of vinyl | 200 | 200 | 200 | 200 | 200 | 200 | 200 | 200 |
| | | chloride paste | | | | | | | | |
| | | (parts by | | | | | | | | |
| | | weight) | | | | | | | | |

| | | | | | | | | |
|---|---|---|---|---|---|---|---|---|
| Specific gravity of compound | 1.00 | 1.00 | 1.00 | 1.00 | 1.00 | 1.00 | 1.00 | 1.00 |

| | | | | | | | | | |
|---|---|---|---|---|---|---|---|---|---|
| Specific gravity | 20 MPa × 20 min | 1.00 | 1.00 | 1.00 | 1.00 | 1.00 | 1.00 | 1.01 | 1.01 |
| of the compound | 20 MPa × 1 h | 1.05 | 1.08 | 1.04 | 1.01 | 1.02 | 1.01 | 1.01 | 1.04 |
| after pressure | 20 MPa × 5 h | 1.10 | 1.12 | 1.06 | 1.02 | 1.03 | 1.01 | 1.02 | 1.05 |
| application | 20 MPa × 24 h | 1.14 | 1.15 | 1.08 | 1.03 | 1.07 | 1.02 | 1.03 | 1.08 |
| Deformation ratio of | 20 MPa × 24 h | 53 | 50 | 72 | 88 | 76 | 93 | 89 | 71 |
| the hollow particles | Evaluation | Acceptable | Acceptable | Good | Good | Good | Good | Good | Good |
| after pressure | | | | | | | | | |
| application (R) | | | | | | | | | |

TABLE 8

| | | | Test No. | | | |
|---|---|---|---|---|---|---|
| | | | 9 | 10 | 11 | 12 |
| Vinyl chloride | Lightweight filler | Hollow particles | Fine-particle- | Fine-particle- | Fine-particle- | Fine-particle- |
| compound | | | coated hollow | coated hollow | coated hollow | coated hollow |
| | | | particles 9 | particles 10 | particles 11 | particles 12 |
| | | True specific gravity | 0.10 | 0.11 | 0.15 | 0.18 |
| | | Amount (parts by weight) | 5.1 | 5.7 | 8.1 | 10.1 |
| | Base material | Specific gravity of vinyl | 1.3 | 1.3 | 1.3 | 1.3 |
| | | chloride paste | | | | |
| | | Amount of vinyl chloride | 200 | 200 | 200 | 200 |
| | | paste (parts by weight) | | | | |
| | Specific gravity of compound | | 1.00 | 1.00 | 1.00 | 1.00 |
| Specific gravity of the compound after | | 20 MPa × 20 min | 1.03 | 1.02 | 1.03 | 1.05 |
| pressure application | | 20 MPa × 1 h | 1.06 | 1.02 | 1.05 | 1.10 |
| | | 20 MPa × 5 h | 1.07 | 1.03 | 1.07 | 1.12 |
| | | 20 MPa × 24 h | 1.12 | 1.03 | 1.08 | 1.16 |
| Deformation ratio of the hollow particles | | 20 MPa × 24 h | 57 | 89 | 72 | 49 |
| after pressure application (R) | | Evaluation | Acceptable | Good | Good | Acceptable |
| | | | Test No. | | | |
| | | | 13 | 14 | 15 | 16 |
| Vinyl chloride | Lightweight filler | Hollow particles | Hollow | Hollow | Hollow | Fine-particle- |
| compound | | | particles 13 | particles 14 | particles 15 | coated hollow |
| | | | | | | particles A |
| | | True specific gravity | 0.058 | 0.044 | 0.040 | 0.16 |
| | | Amount (parts by weight) | 2.8 | 2.1 | 1.9 | 8.8 |
| | Base material | Specific gravity of vinyl | 1.3 | 1.3 | 1.3 | 1.3 |
| | | chloride paste | | | | |
| | | Amount of vinyl chloride | 200 | 200 | 200 | 200 |
| | | paste (parts by weight) | | | | |
| | Specific gravity of compound | | 1.00 | 1.00 | 1.00 | 1.00 |

| | | | | | |
|---|---|---|---|---|---|
| Specific gravity of the compound after | 20 MPa × 20 min | 1.01 | 1.00 | 1.00 | 1.20 |
| pressure application | 20 MPa × 1 h | 1.01 | 1.04 | 1.01 | 1.29 |
| | 20 MPa × 5 h | 1.02 | 1.05 | 1.01 | 1.30 |
| | 20 MPa × 24 h | 1.02 | 1.05 | 1.02 | 1.30 |
| Deformation ratio of the hollow particles | 20 MPa × 24 h | 93 | 81 | 93 | 12 |
| after pressure application (R) | Evaluation | Good | Good | Good | Poor |

TABLE 9

| Test No. | | | 17 | 18 | 19 | 20 | 21 | 22 | 23 |
|---|---|---|---|---|---|---|---|---|---|
| Vinyl | Lightweight | Hollow | Fine- | Fine- | Fine- | Fine- | Fine- | Fine- | Fine- |
| chloride | filler | particles | particle- | particle- | particle- | particle- | particle- | particle- | particle- |
| compound | | | coated | coated | coated | coated | coated | coated | coated |
| | | | hollow | hollow | hollow | hollow | hollow | hollow | hollow |
| | | | particles B | particles C | particles D | particles E | particles 16 | particles 17 | particles 18 |
| | | True specific | 0.16 | 0.11 | 0.18 | 0.15 | 0.16 | 0.15 | 0.14 |
| | | gravity | | | | | | | |
| | | Amount | 8.8 | 5.7 | 10.1 | 8.1 | 8.8 | 8.1 | 7.5 |
| | | (parts by | | | | | | | |
| | | weight) | | | | | | | |
| | Base | Specific | 1.3 | 1.3 | 1.3 | 1.3 | 1.3 | 1.3 | 1.3 |
| | material | gravity | | | | | | | |
| | | of vinyl | | | | | | | |
| | | chloride paste | | | | | | | |
| | | Amount of vinyl | 200 | 200 | 200 | 200 | 200 | 200 | 200 |
| | | chloride paste | | | | | | | |
| | | (parts by weight) | | | | | | | |

| | | | | | | | |
|---|---|---|---|---|---|---|---|
| Specific gravity of compound | 1.00 | 1.00 | 1.00 | 1.00 | 1.00 | 1.00 | 1.00 |

| | | | | | | | | |
|---|---|---|---|---|---|---|---|---|
| Specific gravity | 20 MPa × 20 min | 1.15 | 1.01 | 1.16 | 1.05 | 1.00 | 1.00 | 1.00 |
| of the compound | 20 MPa × 1 h | 1.23 | 1.03 | 1.22 | 1.23 | 1.02 | 1.01 | 1.00 |
| after pressure | 20 MPa × 5 h | 1.30 | 1.15 | 1.28 | 1.30 | 1.05 | 1.04 | 1.04 |
| application | 20 MPa × 24 h | 1.30 | 1.21 | 1.30 | 1.30 | 1.07 | 1.06 | 1.05 |
| Deformation ratio of | 20 MPa × 24 h | 12 | 31 | 14 | 12 | 75 | 79 | 82 |
| the hollow particles | Evaluation | Poor | Poor | Poor | Poor | Good | Good | Good |
| after pressure | | | | | | | | |
| application (R) | | | | | | | | |

The results of Tests 1 to 15 and 21 to 23 described above showed that the shell of the (fine-particle-coated) hollow particles manufactured from the heat-expandable microspheres containing the organic silicon compound (which has T unit represented by R¹SiO_{3/2} and D unit represented by R²²SiO_{3/2} with each R¹ and R² being a monovalent organic group) was supported by the heat-treated product of the organic silicon compound. Thus the vinyl chloride compounds containing such (fine-particle-coated) hollow particles maintained their specific gravity with minimum change after the compounds were subjected to a pressure of 20 MPa or higher even for a long time, and the deformation of the shell of (fine-particle-coated) hollow particles was prevented to attain sufficient lightweight effect.

On the other hand, the results of Tests 16 to 20 described above showed that the shell of the (fine-particle-coated) hollow particles manufactured from the heat-expandable microspheres which did not contain the organic silicon compound was not supported by the heat-treated product of the organic silicon compound. Thus the vinyl chloride compounds containing such (fine-particle-coated) hollow particles failed to maintain their specific gravity after the compounds were subjected to a pressure of 20 MPa or higher especially for a long time. Thus the deformation of the shell of the (fine-particle-coated) hollow particles was not prevented and sufficient lightweight effect was not attained.

### INDUSTRIAL APPLICABILITY

The heat-expandable microspheres of the present invention are manufactured into hollow particles which resist rupturing or denting of their shell against a high pressure load better than hollow particles manufactured from conventional heat-expandable microspheres.

The hollow particles manufactured from the heat-expandable microspheres of the present invention resist rupturing or denting of their shell against a high pressure load, and are preferably used in applications including, for example, automotive body sealants, automotive undercoat materials, automotive damping paints and sealants for buildings.

The heat-expandable microspheres of the present invention are applicable as a lightweight filler for putties, paints, inks, sealing materials, mortar, paper clay and potteries and can be blended with a base component to be processed by injection molding, extrusion molding or press molding and manufactured into formed product having good properties of sound insulation, heat insulation, heat shielding and sound absorbency.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

1. Heat-expandable microspheres comprising a shell containing a thermoplastic resin, a thermally gasifiable blowing agent and an organic silicon compound;
wherein the blowing agent is encapsulated in the shell;
wherein the organic silicon compound exists below the outside surface of the shell and/or on the outside surface of the shell;
wherein the organic silicon compound contains at least one unit selected from T unit represented by R¹SiO_{3/2} and D unit represented by R²₂SiO_{2/22}; and
wherein each of R and R² is a monovalent organic group having 1 to 15 carbon atoms.

2. Heat-expandable microspheres according to claim 1, wherein the organic silicon compound has a silanol group and/or an alkoxysilyl group.

3. Heat-expandable microspheres according to claim 1,
wherein the thermoplastic resin is a polymer of a polymerizable component containing a uncross-linkable monomer having one polymerizable carbon-carbon double bond; and
wherein the uncross-linkable monomer contains a nitrile monomer.

4. Heat-expandable microspheres according to claim 1,
wherein the thermoplastic resin is a polymer of a polymerizable component containing a uncross-linkable monomer having one polymerizable carbon-carbon double bond; and
wherein the uncross-linkable monomer contains a carboxyl-group-containing monomer.

5. Heat-expandable microspheres according to claim 1,
wherein a content of the organic silicon compound ranges from 0.05 to 50 parts by weight to 100 parts by weight of the heat-expandable microspheres.

6. Hollow particles manufactured by expanding the heat-expandable microspheres according to claim 1.

7. Hollow particles comprising a shell containing a thermoplastic resin, a hollow portion surrounded by the shell, and an organic silicon compound;
wherein the organic silicon compound exists below the outside surface of the shell and/or on the outside surface of the shell;
wherein the organic silicon compound contains at least one unit selected from T unit represented by R¹SiO_{3/2} and D unit represented by R²₂SiO_{2/2}; and
wherein each of R and R² is a monovalent organic group having 1 to 15 carbon atoms.

8. Hollow particles according to claim 7, the hollow particles having a specific gravity ranging from 0.005 to 0.6.

9. Fine-particle-coated hollow particles comprising the hollow particles according to claim 6 and a fine particle coating the outside surface of the shell of the hollow particles.

10. A composition comprising a base component and the heat-expandable microspheres according to claim 1.

11. A formed product manufactured by forming the composition according to claim 10.

12. A composition comprising a base component and the hollow particles according to claim 6.

13. A composition comprising a base component and the fine-particle-coated hollow particles according to claim 9.

14. A formed product manufactured by forming the composition according to claim 12.

15. A formed product manufactured by forming the composition according to claim 13.

16. Heat-expandable microspheres according to claim 2,
wherein the thermoplastic resin is a polymer of a polymerizable component containing a uncross-linkable monomer having one polymerizable carbon-carbon double bond; and
wherein the uncross-linkable monomer contains a nitrile monomer.

17. Heat-expandable microspheres according claim 2,
wherein the thermoplastic resin is a polymer of a polymerizable component containing a uncross-linkable monomer having one polymerizable carbon-carbon double bond; and
wherein the uncross-linkable monomer contains a carboxyl-group-containing monomer.

18. Heat-expandable microspheres according to claim 2,
wherein a content of the organic silicon compound ranges from 0.05 to 50 parts by weight to 100 parts by weight of the heat-expandable microspheres.

19. Hollow particles manufactured by expanding the heat-expandable microspheres according to claim 2.

20. Fine-particle-coated hollow particles comprising the hollow particles according to claim 7 and a fine particle coating the outside surface of the shell of the hollow particles.
